(19) United States
(12) Patent Application Publication
(10) Pub. No.: US 2021/0012322 A1
(43) Pub. Date: Jan. 14, 2021

(54) SYSTEMS, METHODS AND COMPUTER PROGRAM PRODUCTS FOR MOBILE DEVICE BASED PAYMENT TRANSACTIONS THROUGH NEAR FIELD COMMUNICATION WITH A CONTACTLESS PAYMENT CARD

(71) Applicant: Mastercard International Incorporated, Purchase, NY (US)

(72) Inventors: Lalit Manchanda, Gurgaon (IN); Ajay Sinha, Pune (IN); Naveen Kumar Gupta, Pune (IN)

(73) Assignee: Mastercard International Incorporated, Purchase, NY (US)

(21) Appl. No.: 16/920,072

(22) Filed: Jul. 2, 2020

(30) Foreign Application Priority Data
Jul. 10, 2019 (IN) 201911027718

(51) Int. Cl. G06Q 20/34; G06Q 20/40; G06Q 20/38

(52) U.S. Cl. CPC G06Q 20/352; G06Q 2220/00; G06Q 20/38215; G06Q 20/401

(57) ABSTRACT

The invention provides methods, systems and computer program products for implementing a contactless payment card based payment transaction. The invention may in an embodiment be implemented by (i) establishing a contactless communication protocol based data channel with a contactless payment card through a processor implemented contactless communication enabled device, (ii) receiving payment card information from the contactless payment card over the contactless communication protocol based data channel, (iii) transmitting to a kernel server, a payment transaction request for onward transmission to an issuer server associated with the contactless payment card, the payment transaction request identifying a payment amount, a payee account, and payment account associated with the contactless payment card, (iv) receiving from the kernel server, a validation cryptogram, request wherein the validation cryptogram request has been generated by the issuer server transmitting the validation cryptogram to the kernel server, for onward transmission to the issuer server.

### CROSS REFERENCE TO RELATED APPLICATIONS

This application claims priority to Indian Application No. 201911027718, filed Jul. 10, 2019, which is incorporated herein by reference in its entirety

### FIELD OF THE INVENTION STACK

The present invention relates to the domain of payment card transactions, and more particularly to systems, methods and computer program products for contactless payment card based payment transactions using mobile devices having near field communication capabilities.

### BACKGROUND OF THE INVENTION

Mobile communication devices (“mobile devices”) are capable of being configured for several functions. Typical mobile devices include functionality for data and voice communications, imaging and video capture, voice storage, audio reproduction and playback, image or video display, and the like. Touch based control functionality is also now a standard feature of mobile devices—which has been found to considerably simplify the user interface aspect of such devices. In addition, mobile devices are now commonly available with near field communication (“NFC”) capabilities.

Near field communication refers to a contactless-type short-range wireless communication that operates at a frequency bandwidth of 13.56 MHz. Near field communication comprises technology that requires a short distance of approximately 10 cm to transmit data between terminals equipped with an NFC transceiver. Near field communication is excellent in proximity, bi-directionality, and security, compared to other communication technologies, and has an advantage of establishing two way communication between terminals in 1/10 second or less without requiring complex pairing. As a result, near field communication technology is also now routinely incorporated within payment cards such as credit cards or debit cards—for enabling contactless payment transactions.

A common type of electronic payment transaction involves initiating payment by presenting the payment card at a POS terminal, and inputting the transaction amount and payor authentication information (for example a personal identification number (PIN), password, passcode, or one-time password (OTP)) at the point-of-sale (POS) terminal. The transaction amount and payor authentication information is electronically forwarded (through an acquirer associated with the POS terminal and a centralized payment network associated with the payment card) to an issuer associated with the payor's payment account—whereafter the issuer decides whether to authorize the transaction, based on (i) a determination that the transaction amount is less than an available balance associated with the payor's payment account, and (ii) successful authentication of the payor's identity using the received authentication information.

It has been found that the process steps involving swiping the magnetic stripe of a payment card in a POS terminal, and input of authentication information and/or transaction amount information at the POS terminal is generally considered inconvenient and interferes with the overall payment experience. Further, the wait time associated with card swipe events has also been found to be relatively greater than when compared with the wait time in the case of contactless payments. Contactless payment transactions have therefore been gaining increasing popularity—as a result of the lower wait time, and also in view of the fact that for transactions under a predefined value, the requirement for input of payor authentication information can be avoided in certain jurisdictions for such transactions. With the additional threat of virus and bacteria borne contamination and health risks, contactless payments are increasingly the more attractive option.

Additionally, given the increasing popularity of electronic commerce and electronic payment transactions, there has been a steep increase in payment card transactions being effected through mobile devices. Again, such transactions require correct input of card information, and payor authentication information—which reduces the convenience and user friendliness.

There is accordingly a need to enable contactless payment card based transactions for payment transactions being implemented through mobile devices.

### BRIEF DESCRIPTION OF THE ACCOMPANYING DRAWINGS

FIGS. 1A and 1B illustrate features of a contactless payment card.

FIG. 2 illustrates a system environment for a contactless payment transaction.

FIG. 3 illustrates components within a POS terminal configured for contactless payment transaction capabilities.

FIG. 4A illustrates a system environment for implementing a mobile device based contactless payment transaction in accordance with the teachings of the present invention.

FIG. 4B illustrates in more detail the Kernel Server of the system environment of FIG. 4A.

FIG. 5A illustrates a system environment for implementing a plurality of mobile device based contactless payment transactions through a plurality of mobile devices in accordance with the teachings of the present invention.

FIG. 5B illustrates in more detail the Kernel Server of the system environment of FIG. 4A.

FIG. 6 is a flowchart illustrating a method for registering a merchant for offering mobile device based contactless payment transaction capabilities to its clients.

FIG. 7 is a flowchart illustrating a method for registering an acquirer, for offering acquirer services to a merchant who is registered for offering mobile device based contactless payment transaction capabilities to clients.

FIG. 8 is a flowchart illustrating a method for effecting a contactless payment transaction in accordance with the teachings of the present invention.

FIG. 9 is a communication flow diagram illustrating communication flow between system entities for implementing the method of FIG. 8.

FIG. 10 is a flowchart illustrating a method for effecting a contactless payment transaction through an electronic transaction platform, in accordance with the teachings of the present invention.

FIG. 11 is a communication flow diagram illustrating communication flow between system entities for implementing the method of FIG. 10.

FIG. 12 is a flowchart illustrating a method for effecting a contactless payment transaction through a merchant device, in accordance with the teachings of the present invention.

FIG. 13 is a communication flow diagram illustrating communication flow between system entities for implementing the method of FIG. 12.

FIG. 14 illustrates an exemplary mobile device configured in accordance with the teachings of the present invention.

FIG. 15 illustrates an exemplary Kernel Server configured in accordance with the teachings of the present invention.

FIG. 16 illustrates an exemplary computer system according to which various embodiments of the present invention may be implemented.

### SUMMARY

The invention provides systems, methods and computer program products for contactless payment card based payment transactions using mobile devices having near-field-communication capabilities.

In an embodiment, the invention provides a system for implementing a contactless payment card based payment transaction. The system comprises at least one processor implemented contactless communication enabled device configured for contactless communication and for network communication, and configured for (i) establishing a contactless communication protocol based data channel with a contactless payment card through the at least one processor implemented contactless communication enabled device, (ii) receiving payment card information from the contactless payment card over the contactless communication protocol based data channel, (iii) transmitting to a kernel server, a payment transaction request for onward transmission to an issuer server associated with the contactless payment card, the payment transaction request identifying a payment amount, a payee account, and payment account associated with the contactless payment card, (iv) receiving from the kernel server, a validation cryptogram request, wherein the validation cryptogram request has been generated by the issuer server, and (v) transmitting the validation cryptogram from the contactless payment card to the kernel server, for onward transmission to the issuer server.

The system may be configured such that (i) the kernel server is certified for implementing a set of communication protocols that enable implementation of the payment transaction through the issuer server, or (ii) the contactless communication enabled device is uncertified for implementing the set of communication protocols that enable implementation of the payment transaction through the issuer server.

The system may in an embodiment be configured such that the payment transaction request transmitted to the kernel server (i) is transmitted as part of one or more data messages that are in a format that is different from a format necessarily required by one or more of the payment network, acquirer network or issuer network for transaction processing or transaction authentication or transaction validation, or (ii) is transmitted as part of one or more data messages that are in a message format that is non-compliant with or that is different from a predefined Europay-Mastercard-Visa (EMV) message format that is necessarily required by one or more of the payment network, acquirer network or issuer network for transaction processing or transaction authentication or transaction validation, or (iii) is transmitted as part of one or more data messages that is uncertified under one or more certification protocols that are necessarily required by one or more of the payment network, acquirer network or issuer network for transaction processing or transaction authentication or transaction validation, or (iv) is transmitted as part of one or more data messages that are uncertified under one or more EMV certification protocols that are necessarily required by one or more of the payment network, acquirer network or issuer network for transaction processing or transaction authentication or transaction validation.

The kernel server may be configured to transmit the payment transaction request onward to the issuer server, such that said onward transmitted payment transaction request (i) is transmitted as part of one or more data messages that are in a format that is compliant with a format necessarily required by one or more of the payment network, acquirer network or issuer network for transaction processing or transaction authentication or transaction validation, or (ii) is transmitted as part of one or more data messages that are in a message format that is compliant with the predefined EMV message format that is necessarily required by one or more of the payment network, acquirer network or issuer network for transaction processing or transaction authentication or transaction validation, or (iii) is transmitted as part of one or more data messages that are certified under one or more certification protocols that are necessarily required by one or more of the payment network, acquirer network or issuer network for transaction processing or transaction authentication or transaction validation, or (iv) is transmitted as part of one or more data messages that are certified under one or more EMV certification protocols that are necessarily required by one or more of the payment network, acquirer network or issuer network for transaction processing or transaction authentication or transaction validation.

The kernel server may be configured to (i) establish at least one additional contactless communication protocol based data channel with at least one additional contactless payment card through an additional processor implemented contactless communication enabled device, (ii) receive payment card information from the additional contactless payment card over the additional contactless communication protocol based data channel, (iii) receive an additional payment transaction request for onward transmission to an additional issuer server associated with the additional contactless payment card, the additional payment transaction request identifying an additional payment amount, an additional payee account, and additional payment account associated with the additional contactless payment card, (iv) receive an additional validation cryptogram request, wherein the additional validation cryptogram request has been generated by the issuer server, and (v) receive the additional validation cryptogram from the additional contactless payment card, for onward transmission to the issuer server.

The issuer server may be configured for one or more of (i) authenticating the requested payment transaction based on the validation cryptogram received from the kernel server, (ii) implementing the requested payment transaction responsive to successful validation cryptogram based authentication of the requested payment transaction, and (iii) transmitting a transaction confirmation message to the contactless communication enabled device through the kernel server.

The invention additionally provides a method for implementing a contactless payment card based payment transaction. The method may comprise implementing at, at least one processor implemented contactless communication enabled device configured for contactless communication and for network communication, the steps of (i) establishing a contactless communication protocol based data channel with a contactless payment card through the at least one processor implemented contactless communication enabled device, (ii) receiving payment card information from the contactless payment card over the contactless communication protocol based data channel, (iii) transmitting to a kernel server, a payment transaction request for onward transmission to an issuer server associated with the contactless payment card, the payment transaction request identifying a payment amount, a payee account, and payment account associated with the contactless payment card, (iv) receiving from the kernel server, a validation cryptogram, request wherein the validation cryptogram request has been generated by the issuer server, and (v) transmitting the validation cryptogram from the contactless payment card to the kernel server, for onward transmission to the issuer server.

The method may additionally include any of the method steps described in the detailed description below.

The invention also provides a computer program product for implementing a contactless payment card based payment transaction. The computer program product comprises a non-transitory computer usable medium having a computer readable program code embodied therein, the computer readable program code comprising instructions for (i) establishing a contactless communication protocol based data channel with a contactless payment card through at least one processor implemented contactless communication enabled device, (ii) receiving payment card information from the contactless payment card over the contactless communication protocol based data channel, (iii) transmitting to a kernel server, a payment transaction request for onward transmission to an issuer server associated with the contactless payment card, the payment transaction request identifying a payment amount, a payee account, and payment account associated with the contactless payment card, (iv) receiving from the kernel server, a validation cryptogram, request wherein the validation cryptogram request has been generated by the issuer server, and (v) transmitting the validation cryptogram from the contactless payment card to the kernel server, for onward transmission to the issuer server.

In various embodiments, the computer program product comprises computer readable program code configured to cause a processor to implement any of the method steps described below in the detailed description.

### DETAILED DESCRIPTION

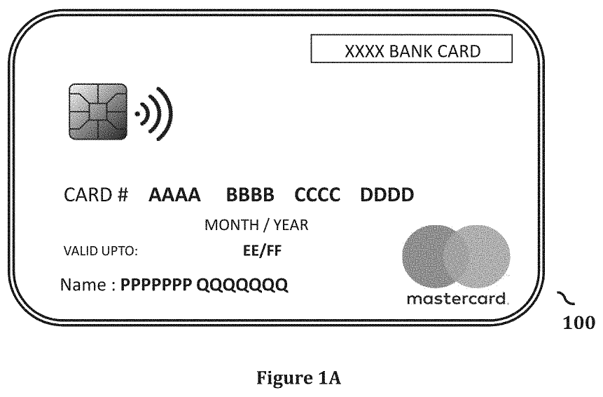

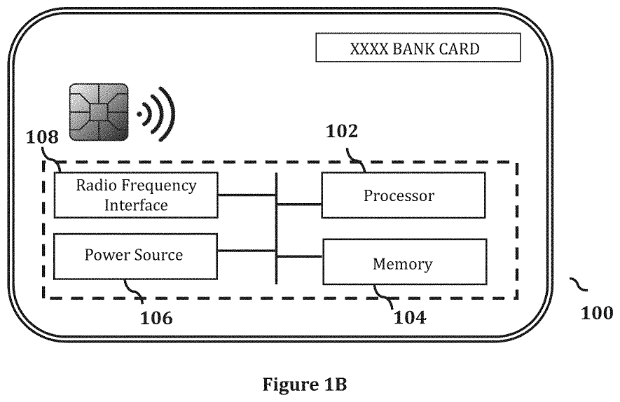

FIG. 1A illustrates a contactless payment card 100 of a type commonly used—comprising a plastic substrate having card information printed thereon (for example, the card holder's name, validity period, issuer name, payment institution name and a card verification value or card verification code), and a magnetic stripe (not shown) disposed on the surface of the substrate—which encodes and stores all or part of the printed card information, along with additional information, a microprocessor or smartchip that is configured to interact with a point-of-sale (POS) terminal, and/or a wireless device for enabling a POS terminal having wireless capabilities to receive and/or send data from/to the payment card.

FIG. 1B illustrates internal components of payment card 100—comprising processor 102, memory 104, power source 106 and radio frequency interface 108. Radio frequency interface 108 may be configured for enabling near field communication protocol based data communication
and may in an embodiment comprise a wireless transceiver capable of communicating with one or more other devices having near field communication capabilities.

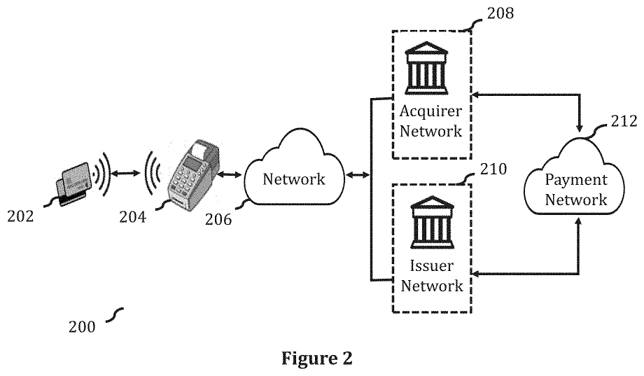

FIG. 2 illustrates a system environment 200 for implementing a POS terminal based contactless payment transaction, where contactless payment card 202 is brought in proximity with POS terminal 204 having near field communication capabilities—and a payment transaction is initiated based on wireless communication between contactless payment card 202 and POS terminal 204. A payment instruction comprising one or more of the contactless payment card identifier, payee account identifier, payment amount and a cryptogram generated by contactless payment card 202, is transmitted by POS terminal 204 through network 206 to acquirer network 208 (a data network maintained by an acquirer institution with which the payee account is maintained). Acquirer network 208 in turn transmits the payment instruction to issuer network 210 (a data network maintained by an issuer institution which has issued contactless payment card 202 to the corresponding payor) through payment network 212 (a data network maintained by an intermediary between the payee's acquirer and the payor's issuer—for example, Mastercard® or Visa®). Subject to successful authorization of the payment card (e.g. authorization based on validation of the cryptogram generated by contactless payment card 202), the requested payment is authorized and the payment amount is transferred from a payment account associated with contactless payment card 202 to the payee account. Confirmation of successful transaction completion may thereafter be transmitted back to POS terminal 204.

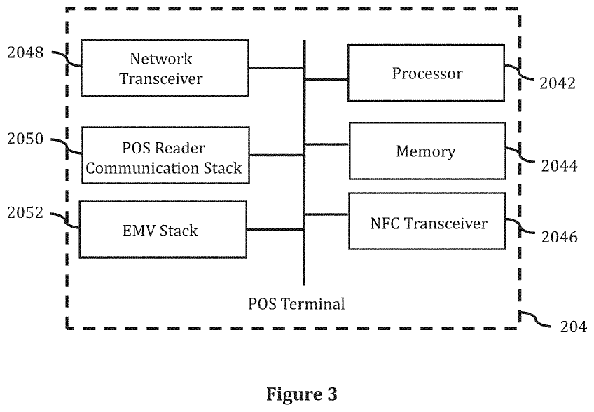

FIG. 3 illustrates a POS terminal 204 having contactless communication capabilities, which has been configured to effect the above described contactless payment transaction process flow. As shown in FIG. 3, POS terminal 204 includes (i) processor 2042, (ii) memory 2044, (iii) NFC transceiver 2046 configured to send and receive data communications based on a near field communication protocol, (iv) a network transceiver 2048 configured to send and receive data communications over a data network (for example a TCP/IP network, the internet, or any other data network), (v) POS reader communication stack 2050 comprising at least a set of communication protocols configured to enable POS terminal 204 to communicate with at least one other device having near field communication capabilities, using near field communication standards and/or over a near field communication protocol based data channel, and (vi) an EMV stack 2052 comprising at least a set of communication protocols configured to enable POS terminal 204 to communicate with one or more of payment networks, acquirer networks and issuer networks based on the Europay-Mastercard-Visa (EMV) communication protocols for the purposes of implementing electronic payment card based transactions.

Replicating the configuration and/or components of POS terminal 204 within a mobile device for the purpose of providing near field communication based contactless payment capabilities has been found to present certain challenges—which are sought to be avoided by the present invention. The invention helps improve the user experience for e-commerce transactions for consumers. Simultaneously the invention reduces the processing load or processing requirements on the transaction enabling terminal (for example on the merchant's transaction enabling terminal), thereby making the terminals themselves and the transactions more secure. This invention also addresses existing obstacles to a mobile device being permitted to implement both of a POS reader communication stack 2050 and EMV stack 2052, despite the fact that such mobile device may not have been appropriately certified for such downloads/implementation. Additionally, the invention eliminates implementation of the EMV stack 2052 on a mobile device entirely. Implementing the EMV stack on a mobile device has been found to increase the susceptibility of both the EMV stack and the underlying payment environment to security threats and hacking threats. This is believed to be a consequence of the fact that mobile devices lack the security provisions typically associated with dedicated hardware devices.

The invention addresses the above challenges by implementing the POS reader communication stack within a software application or within one or more software development kit (SDK) files that is/are implemented within a mobile device, while simultaneously implementing the EMV stack on a Kernel Server that is separate from the mobile device—and with which, the software application implemented on the mobile device is configured to communicate through network communication protocols. This configuration enables the mobile device to communicate with contactless payment cards over near field communication protocols for the purposes of obtaining a payment transaction instruction, while simultaneously ensuring that the EMV stack can be implemented on a server which has been appropriately certified for EMV stack implementation, and which is also appropriately secured or firewalled against malicious attacks or security threats.

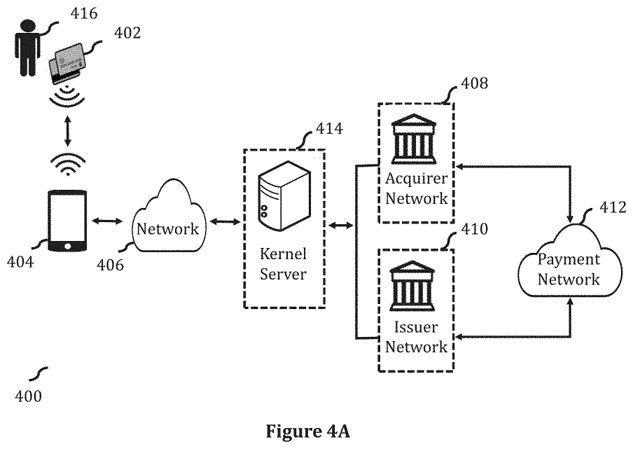

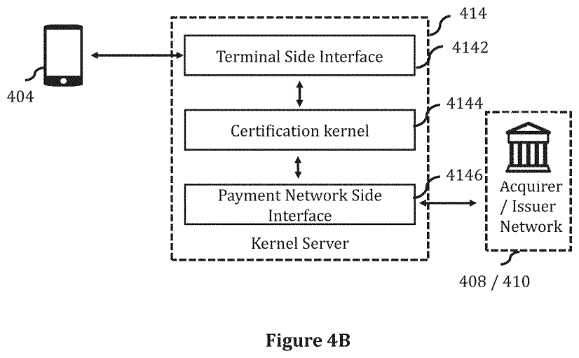

FIG. 4A illustrates a system environment 400 for implementing mobile device based contactless payment transactions. As shown, system environment 400 includes a contactless payment card 402, mobile device 404, communication network 406, acquirer network 408 (a data network maintained by an acquirer institution with which the payee account is maintained), issuer network 410 (a data network maintained by an issuer institution which has issued contactless payment card 402 to the corresponding payor), payment network 412 (a data network maintained by an intermediary between the payee's acquirer and the payor's issuer—for example, Mastercard® or Visa®), and Kernel Server 414. The Kernel Server 414 may be implemented or provided by any one of various entities, including for example, a merchant, the acquirer institution, the issuer institution, the payment network, or by the communication network.

Mobile device 404 has stored within a local memory, a software application or one or more SDK (software development kit) files that comprise a POS reader communication stack—wherein said POS reader communication stack comprises at least a set of communication protocols configured to enable mobile device 404 to communicate with contactless payment cards having near field communication capability, based on near field communication standards and/or over a near field communication data channel. In an embodiment, mobile device 404 is a device that is uncertified or uncertifiable for the purposes of implementation of an EMV stack or EMV software component thereon. In one embodiment, mobile device 404 is a processor implemented contactless communication enabled device that is configured for contactless communication and for network communication.

Kernel Server 414 has stored within an accessible memory location, a stack comprising at least a set of communication protocols configured to enable Kernel Server 414 to communicate with one or more of payment networks, acquirer networks and issuer networks based on the EMV standard communication protocols for the purposes of implementing electronic payment card based transactions. In an embodiment, the Kernel Server 414 is an EMV stack server that is certified or certifiable for the purposes of implementation of an EMV stack or EMV software component thereon.

In operation, a payment transaction is initiated based on wireless communication between contactless payment card 402 (which is placed in proximity of mobile device 404 for the purposes of initiating a payment transaction, by payor 416), and mobile device 404. The contactless payment card identifier, payee account identifier, payment amount and a cryptogram generated by contactless payment card 402, are transmitted by mobile device 404 through network 406 to Kernel Server 414. It would be understood that one or more software application files or SDK files stored in mobile device 404 may be configured to enable secure data communication between mobile device 404 and Kernel Server 414. In an embodiment, the data transmitted by mobile device 404 through network 406 to Kernel Server 414:
(i) is transmitted as part of one or more data messages that are in a format that is different from a format necessarily required by one or more of the payment network, acquirer network or issuer network for transaction processing or transaction authentication or transaction validation, or
(ii) is transmitted as part of one or more data messages that are in a message format that is non-compliant with or that is different from a predefined EMV message format that is necessarily required by one or more of the payment network, acquirer network or issuer network for transaction processing or transaction authentication or transaction validation, or
(iii) is transmitted as part of one or more data messages that omit or lack a certification (i.e. are uncertified) under one or more certification protocols that are necessarily required by one or more of the payment network, acquirer network or issuer network for transaction processing or transaction authentication or transaction validation, or
(iv) is transmitted as part of one or more data messages that omit or lack a certification (i.e. are uncertified) under one or more EMV certification protocols that are necessarily required by one or more of the payment network, acquirer network or issuer network for transaction processing or transaction authentication or transaction validation.

Kernel Server 414 is configured to receive the information or data messages transmitted from mobile device 404, and to generate based on the received information, a payment request seeking transfer of the payment amount from a payor account corresponding to the contactless payment card identifier to a payee account corresponding to the payee account identifier (e.g. a merchant payment account). The generated payment request is transmitted to acquirer network 408. Acquirer network 408 in turn transmits the payment request to issuer network 410 through payment network 412. It would be understood that one or more software application files or SDK files stored in Kernel Server 414 may be configured to (i) enable secure data communication between Kernel Server 414 and mobile device 404, and/or (ii) enable Kernel Server 414 to communicate with one or more of payment networks, acquirer networks and issuer networks based on the EMV standard communication protocols for the purposes of implementing electronic payment card based transactions.

In an embodiment, the payment request generated and transmitted by the Kernel Server 414:
(i) is transmitted as part of one or more data messages that are in a format that is compliant with a format necessarily required by one or more of the payment network, acquirer network or issuer network for transaction processing or transaction authentication or transaction validation, or
(ii) is transmitted as part of one or more data messages that are in a message format that is compliant with a predefined EMV message format that is necessarily required by one or more of the payment network, acquirer network or issuer network for transaction processing or transaction authentication or transaction validation, or
(iii) is transmitted as part of one or more data messages that include a certification (i.e. are certified) under one or more certification protocols that are necessarily required by one or more of the payment network, acquirer network or issuer network for transaction processing or transaction authentication or transaction validation, or
(iv) is transmitted as part of one or more data messages that include a certification (i.e. are certified) under one or more EMV certification protocols that are necessarily required by one or more of the payment network, acquirer network or issuer network for transaction processing or transaction authentication or transaction validation.

Subject to successful authorization of the payment card (e.g. authorization based on validation of the cryptogram generated by contactless payment card 402), the requested payment is authorized and the payment amount is transferred from a payor payment account associated with contactless payment card 402 to a payee payment account. Confirmation of successful transaction completion may thereafter be transmitted by issuer network 410 back to mobile device 404 via one or more of payment network 412, acquirer network 414, Kernel Server 414 and network 406.

FIG. 4B illustrates in more detail the Kernel Server 414 of the system environment of FIG. 4A. As shown in FIG. 4B, Kernel Server 414 comprises a terminal side interface 4142, a certification kernel 4144 and a payment network side interface 4146.

Terminal side interface 4142 comprises an interface that is configured to interface with mobile device 404 and to receive from mobile device 404 data messages or data transmitted by the mobile device 404 to Kernel Server 414 for the purposes of implementing a payment transaction through a contactless payment card 402 that is in wireless communication with said mobile device 404. The data or data messages received at terminal side interface 4142 from mobile device 414 may include any one or more of a contactless payment card identifier, a payee account identifier, a payment amount and a cryptogram generated by the contactless payment card 402.

Terminal side interface 4142 communicates the data received from mobile device 404 onward to certification kernel 4144. Certification kernel 4144 may comprise a processor implemented kernel that is configured to enable secure data communication between the Kernel Server 414 and any of an issuer network, acquirer network or payment network, and to receive from terminal side interface 4142, data messages (i) that are in a format that are different from, or that are non-compliant with a defined message format that is necessarily required by one or more of the payment network, acquirer network or issuer network for transaction processing or transaction authentication or transaction validation, or (ii) that omit or lack a certification under one or more certification protocols (for example, one or more EMV protocols) that are necessarily required by one or more of the payment network, acquirer network or issuer network for transaction processing or transaction authentication or transaction validation. The certification kernel 4144 is additionally configured to extract data within the one or more received data messages and to generate based on such data, outgoing data messages (i) that are in a format that are the same as, or that are compliant with a defined message format that is necessarily required by one or more of the payment network, acquirer network or issuer network for transaction processing or transaction authentication or transaction validation, or (ii) that are certified under one or more certification protocols (for example, one or more EMV protocols) that are necessarily required by one or more of the payment network, acquirer network or issuer network for transaction processing or transaction authentication or transaction validation.

Certification kernel 4144 may in an embodiment be configured to include or implement one or more software application files or SDK files that have been certified by any an issuer network, acquirer network or payment network, and which are configured to (i) enable secure data communication between Kernel Server 414 and mobile device 404, and/or (ii) enable Kernel Server 414 to communicate with one or more of payment networks, acquirer networks and issuer networks based on the EMV standard communication protocols for the purposes of implementing electronic payment card based transactions. In a particular embodiment, the one or more software application files or SDK files are authorized or permitted for implementation only within one or more certified categories of devices, wherein Kernel Server 414 is one of said certified categories of devices.

The outgoing data messages generated by certification kernel 4144 are transmitted to payment network side interface 4146, said interface 4146 comprising an interface that is configured to interface with any of the acquirer network 408, issuer network 410 or the payment network—for onward transmission of the outgoing data messages.

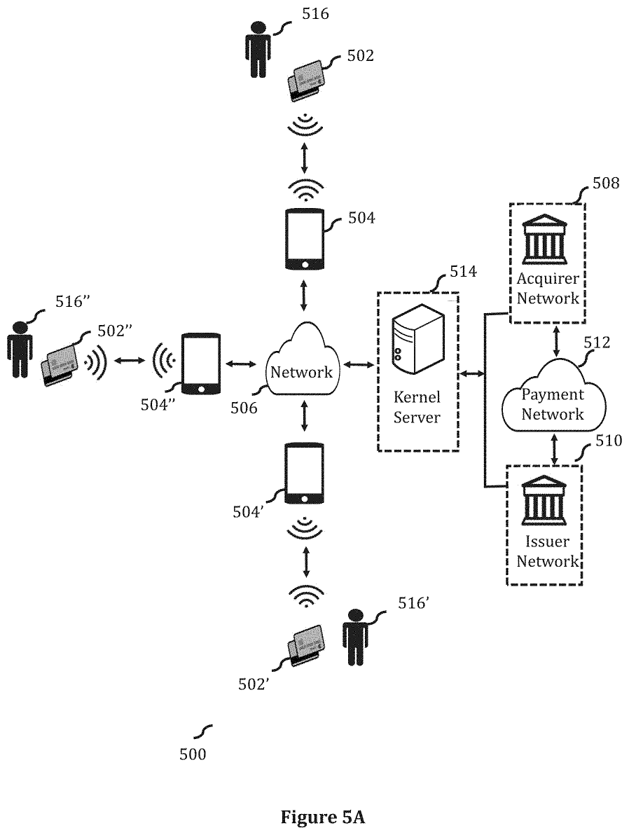

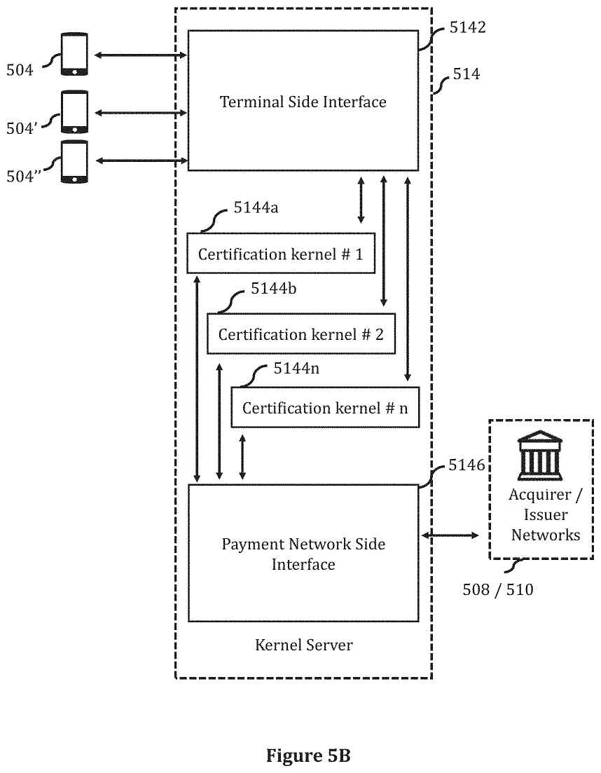

FIG. 5A illustrates another system environment 500 for implementing mobile device based contactless payment transactions, wherein the Kernel Server within the system environment is configured to communicate with, and handle payment requests received from, a plurality of mobile devices. As shown, system environment 500 includes a first contactless payment card 502, first mobile device 504, a second contactless payment card 502′, second mobile device 504′, a third contactless payment card 502″, third mobile device 504′″, a communication network 506, acquirer network 508 (a data network maintained by an acquirer institution with which the payee account is maintained), issuer network 510 (a data network maintained by an issuer institution which has issued contactless payment card 502, 502′ and/or 502″ to the corresponding payor), payment network 512 (a data network maintained by an intermediary between the payee's acquirer and the payor's issuer—for example, Mastercard® or Visa®), and Kernel Server 514. As in the case of the system environment of FIG. 4, the Kernel Server 514 may be implemented or provided by any one of various entities, including for example, a merchant, the acquirer institution, the issuer institution, the payment network, or by the communication network.

Each of mobile device 504, 504′, 504″ has stored within a local memory, a software application or one or more SDK (software development kit) files that comprise a POS reader communication stack—wherein said POS reader communication stack comprises at least a set of communication protocols configured to enable mobile device 504, 504′, 504″ to communicate with contactless payment cards having near field communication capability, based on near field communication standards and/or over a near field communication data channel. In an embodiment, each mobile device 504, 504′, 504″ is a device that is uncertified or uncertifiable for the purposes of implementation of an EMV stack or EMV software component thereon. In various embodiments, each of mobile device 504, 504′, 504″ is a processor implemented contactless communication enabled device that is configured for contactless communication and for network communication.

Kernel Server 514 has stored within an accessible memory location, a stack comprising at least a set of communication protocols configured to enable Kernel Server 514 to communicate with one or more of payment networks, acquirer networks and issuer networks based on the EMV standard communication protocols for the purposes of implementing electronic payment card based transactions. In an embodiment, the Kernel Server 514 is an EMV stack server that is certified or certifiable for the purposes of implementation of an EMV stack or EMV software component thereon.

In operation, a first payment transaction is initiated based on wireless communication between a first contactless payment card 502 (which is placed in proximity of a first mobile device 504 for the purposes of initiating a payment transaction, by a first payor 516), and the first mobile device 504. A first contactless payment card identifier associated with first contactless payment card 502, a first payee account identifier associated with the first payment transaction, a payment amount associated with the first payment transaction and a cryptogram generated by the first contactless payment card 502, are transmitted by first mobile device 504 through network 506 to Kernel Server 514. One or more software application files or SDK files stored in the first mobile device 504 may be configured to enable secure data communication between the first mobile device 504 and Kernel Server 514.

Thereafter, a second payment transaction may be initiated based on wireless communication between a second contactless payment card 502′ (which is placed in proximity of a second mobile device 504′ for the purposes of initiating a payment transaction, by a second payor 516′), and the second mobile device 504′. A second contactless payment card identifier associated with second contactless payment card 502′, a second payee account identifier associated with the second payment transaction, a payment amount associated with the second payment transaction and a cryptogram generated by the second contactless payment card 502′, are transmitted by second mobile device 504′ through network 506 to Kernel Server 514. One or more software application files or SDK files stored in the second mobile device 504′ may be configured to enable secure data communication between the second mobile device 504′ and Kernel Server 514.

Optionally, a third payment transaction may be initiated based on wireless communication between a third contactless payment card 502″ (which is placed in proximity of a third mobile device 504″ for the purposes of initiating a payment transaction, by a third payor 516″), and the third mobile device 504″. A third contactless payment card identifier associated with third contactless payment card 502″, a third payee account identifier associated with the third payment transaction, a payment amount associated with the third payment transaction and a cryptogram generated by the third contactless payment card 502″, are transmitted by third mobile device 504″ through network 506 to Kernel Server 514. One or more software application files or SDK files stored in the third mobile device 504″ may be configured to enable secure data communication between the third mobile device 504″ and Kernel Server 514.

In an embodiment, the data transmitted by any of mobile devices 504, 504′, 504″ through network 506 to Kernel Server 514:
(i) is transmitted as part of one or more data messages that are in a format that is different from a format necessarily required by one or more of the payment network, acquirer network or issuer network for transaction processing or transaction authentication or transaction validation, or
(ii) is transmitted as part of one or more data messages that are in a message format that is non-compliant with or that is different from a predefined EMV message format that is necessarily required by one or more of the payment network, acquirer network or issuer network for transaction processing or transaction authentication or transaction validation, or
(iii) is transmitted as part of one or more data messages that omit or lack a certification (i.e. are uncertified) under one or more certification protocols that are necessarily required by one or more of the payment network, acquirer network or issuer network for transaction processing or transaction authentication or transaction validation, or
(iv) is transmitted as part of one or more data messages that omit or lack a certification (i.e. are uncertified) under one or more EMV certification protocols that are necessarily required by one or more of the payment network, acquirer network or issuer network for transaction processing or transaction authentication or transaction validation.

Kernel Server 514 is configured to receive the information transmitted from each of first, second and third mobile devices 504, 504′, 504″, and to generate based on the received information, (i) a corresponding first payment request seeking transfer of the first payment amount from a first payor account corresponding to the first contactless payment card identifier to a first payee account corresponding to the first payee account identifier (e.g. a merchant payment account), (ii) a corresponding second payment request seeking transfer of the second payment amount from a second payor account corresponding to the second contactless payment card identifier to a second payee account corresponding to the second payee account identifier (e.g. a merchant payment account), and (iii) optionally, a corresponding third payment request seeking transfer of the third payment amount from a third payor account corresponding to the third contactless payment card identifier to a third payee account corresponding to the third payee account identifier (e.g. a merchant payment account).

Each of the generated first, second and optionally third, payment request is transmitted to acquirer network 508. Acquirer network 508 in turn transmits each received payment request to the respective issuer network 510 through payment network 512. As discussed in connection with the system environment of FIG. 4, one or more software application files or SDK files stored in Kernel Server 514 may be configured to (i) enable secure data communication between Kernel Server 514 and mobile device 504, and/or (ii) enable Kernel Server 514 to communicate with one or more of payment networks, acquirer networks and issuer networks based on the EMV standard communication protocols for the purposes of implementing electronic payment card based transactions.

In an embodiment, any of the first, second or third payment requests generated and transmitted by the Kernel Server 514:
(i) is transmitted as part of one or more data messages that are in a format that is compliant with a format necessarily required by one or more of the payment network, acquirer network or issuer network for transaction processing or transaction authentication or transaction validation, or
(ii) is transmitted as part of one or more data messages that are in a message format that is compliant with a predefined EMV message format that is necessarily required by one or more of the payment network, acquirer network or issuer network for transaction processing or transaction authentication or transaction validation, or
(iii) is transmitted as part of one or more data messages that include a certification (i.e. are certified) under one or more certification protocols that are necessarily required by one or more of the payment network, acquirer network or issuer network for transaction processing or transaction authentication or transaction validation, or
(iv) is transmitted as part of one or more data messages that include a certification (i.e. are certified) under one or more EMV certification protocols that are necessarily required by one or more of the payment network, acquirer network or issuer network for transaction processing or transaction authentication or transaction validation.

Subject to successful authorization of the first, second or third payment card (e.g. authorization based on validation of the first, second or third cryptogram generated by the respective first, second or third contactless payment card 502, 502′, 502″), the requested first, second or third payment is authorized and the corresponding payment amount is transferred from a payor payment account associated with the respective first, second or third contactless payment card 502, 502′, 502″ to a payee payment account. Confirmation of successful transaction completion may thereafter be transmitted by issuer network 510 back to the respective mobile device 504, 504′, 504″ via one or more of payment network 512, acquirer network 514, Kernel Server 514 and network 506.

FIG. 5B illustrates in more detail the Kernel Server 514 of the system environment of FIG. 5A. As shown in FIG. 5B, Kernel Server 514 comprises a terminal side interface 5142, a plurality of certification kernels (i.e. certification kernel #1 5144a, certification kernel #2 5144b upto certification kernel #n 5144n), and a payment network side interface 5146.

Terminal side interface 5142 comprises an interface that is configured to interface with a plurality of mobile devices 504, 504′, 504″ and to receive from each mobile device 504, 504′, 504″ data messages or data transmitted by the mobile device 504, 504′, 504″ to Kernel Server 514 for the purposes of implementing respective payment transactions through contactless payment cards 502, 502′, 502″ that are respectively in wireless communication with said mobile devices 504, 504′, 504″. The data or data messages received at terminal side interface 4142 from any of mobile devices 504, 504′, 504″ as part of a request for initiation of a contactless payment card based payment transaction, may include any one or more of a contactless payment card identifier, a payee account identifier, a payment amount and a cryptogram generated by the contactless payment card 402.

Terminal side interface 4142 communicates the data received from any of mobile devices 504, 504′, 504″(as part of a request for initiation of a contactless payment card based payment transaction) onward to one of the plurality of certification kernels 5144a to 5144n. Each certification kernel 5144 may comprise a processor implemented kernel that is configured to enable secure data communication between the Kernel Server 514 and any of an issuer network, acquirer network or payment network. Each certification kernel 5144a to 5144n may be configured to receive from terminal side interface 4142, data messages (i) that are in a format that are different from, or that are non-compliant with a defined message format that is necessarily required by one or more of the payment network, acquirer network or issuer network for transaction processing or transaction authentication or transaction validation, or (ii) that omit or lack a certification under one or more certification protocols (for example, one or more EMV protocols) that are necessarily required by one or more of the payment network, acquirer network or issuer network for transaction processing or transaction authentication or transaction validation. Each certification kernel 5144a to 5144n may be additionally configured to extract data within the one or more received data messages and to generate based on such data, outgoing data messages (i) that are in a format that are the same as, or that are compliant with a defined message format that is necessarily required by one or more of the payment network, acquirer network or issuer network for transaction processing or transaction authentication or transaction validation, or (ii) that are certified under one or more certification protocols (for example, one or more EMV protocols) that are necessarily required by one or more of the payment network, acquirer network or issuer network for transaction processing or transaction authentication or transaction validation.

Each certification kernel 5144a to 5144n may be configured to enable communication between Kernel Server 514 and one of a plurality of payment networks. In an embodiment, each certification kernel 5144a to 5144n is configured to implement communication parameters or communication protocols that are specific to a particular payment network, such that payment requests that are received at Kernel Server 514 from one or more mobile devices 504, 504′, 504″ at the Kernel Server 514 corresponding to contactless payment cards associated with a specific payment network would be forwarded to the certification kernel associated with that specific payment network—for generation and onward transmission (by Kernel Server 514) of a payment request according to the communication parameters or communication protocols that are specific to that particular payment network.

Each certification kernel 5144a to 5144n may in an embodiment be configured to include or implement one or more software application files or SDK files that have been certified by any an issuer network, acquirer network or payment network, and which are configured to (i) enable secure data communication between Kernel Server 414 and mobile device 404, and/or (ii) enable Kernel Server 414 to communicate with one or more of payment networks, acquirer networks and issuer networks based on the EMV standard communication protocols for the purposes of implementing electronic payment card based transactions. In a particular embodiment, the one or more software application files or SDK files are authorized or permitted for implementation only within one or more certified categories of devices, wherein Kernel Server 414 is one of said certified categories of devices. In an embodiment, each certification kernel 5144a to 5144n is configured to implement software application files or SDK files that are configured to enable communication between Kernel Server 514 and a specific payment network within a plurality of payment networks—and to that end, said software application files or SDK files are configured for enabling generation and onward transmission (by Kernel Server 514) of a payment request according to the communication parameters or communication protocols that are specific to that particular payment network.

The outgoing data messages generated by any or each of certification kernels 5144a to 5144n are transmitted to payment network side interface 5146, said interface 5146 comprising an interface that is configured to interface with any of the acquirer network 508, issuer network 510 or a payment network—for onward transmission of the outgoing data messages.

During operation of Kernel Server 514 as illustrated in FIG. 5B, a first payment transaction is initiated based on wireless communication between a first contactless payment card 502 (which is placed in proximity of a first mobile device 504 for the purposes of initiating a payment transaction, by a first payor 516), and the first mobile device 504. A first contactless payment card identifier associated with first contactless payment card 502, a first payee account identifier associated with the first payment transaction, a payment amount associated with the first payment transaction and a cryptogram generated by the first contactless payment card 502, are transmitted by first mobile device 504 through network 506 to Kernel Server 514. One or more software application files or SDK files stored in the first mobile device 504 may be configured to enable secure data communication between the first mobile device 504 and Kernel Server 514.

Thereafter, a second payment transaction may be initiated based on wireless communication between a second contactless payment card 502′ (which is placed in proximity of a second mobile device 504′ for the purposes of initiating a payment transaction, by a second payor 516′), and the second mobile device 504′. A second contactless payment card identifier associated with second contactless payment card 502′, a second payee account identifier associated with the second payment transaction, a payment amount associated with the second payment transaction and a cryptogram generated by the second contactless payment card 502′, are transmitted by second mobile device 504′ through network 506 to Kernel Server 514. One or more software application files or SDK files stored in the second mobile device 504′ may be configured to enable secure data communication between the second mobile device 504′ and Kernel Server 514.

Optionally, a third payment transaction may be initiated based on wireless communication between a third contactless payment card 502″ (which is placed in proximity of a third mobile device 504″ for the purposes of initiating a payment transaction, by a third payor 516″), and the third mobile device 504″. A third contactless payment card identifier associated with third contactless payment card 502″, a third payee account identifier associated with the third payment transaction, a payment amount associated with the third payment transaction and a cryptogram generated by the third contactless payment card 502″, are transmitted by third mobile device 504″ through network 506 to Kernel Server 514. One or more software application files or SDK files stored in the third mobile device 504″ may be configured to enable secure data communication between the third mobile device 504″ and Kernel Server 514.

As discussed above, the data received at Kernel Server 514 from the first, second and third mobile devices 504, 504′, 504″ (i) may be in a format that are different from, or that are non-compliant with a defined message format that is necessarily required by one or more of the payment network, acquirer network or issuer network for transaction processing or transaction authentication or transaction validation, or (ii) may omit or lack a certification under one or more certification protocols (for example, one or more EMV protocols) that are necessarily required by one or more of the payment network, acquirer network or issuer network for transaction processing or transaction authentication or transaction validation.

The data from each mobile device 504′, 504″, 504″ is received by Kernel Server 514 at terminal side interface 5142. The Kernel Server 514 identifies a payment network associated with a contactless payment card that is in wireless communication with the originating mobile device 504, 504′, 504″—and depending on the identified payment network, forwards the received data to a certification kernel 5144a to 5144n that is configured to implement communication parameters or communication protocols that are specific to the identified payment network. The certification kernel 5144a to 5144n that receives the data, is configured to generate, based on such data, outgoing data messages (i) that are in a format that are the same as, or that are compliant with a defined message format that is necessarily required by one or more of the identified payment network, acquirer network or issuer network for transaction processing or transaction authentication or transaction validation, or (ii) that are certified under one or more certification protocols (for example, one or more EMV protocols) that are necessarily required by one or more of the payment network, acquirer network or issuer network for transaction processing or transaction authentication or transaction validation.

It would be understood that if a plurality of the payment transactions initiated at mobile devices 504, 504′ 504″ correspond to the same payment network, they may be transmitted to the same certification kernel 5144a to 5144n for generation of appropriately certified payment transaction requests, and for subsequent onward forwarding. In such cases, the plurality of the payment transactions that are transmitted to the same certification kernel 5144a to 5144n may be processed by the relevant certification kernel in the order that they are received by Kernel Server 514, or according to any other scheduling process that would be apparent to the skilled person.

As discussed above, the outgoing data messages generated each of certification kernels 5144a to 5144n are transmitted to payment network side interface 5146—wherein interface 5146 interfaces with any of the acquirer network 508, issuer network 510 or the identified payment network—for onward transmission of the outgoing data messages.

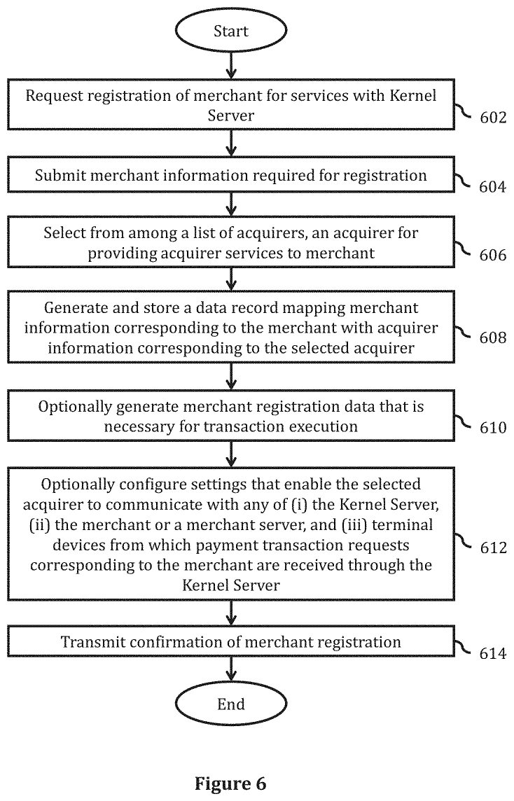

FIG. 6 is a flowchart illustrating a method for registering a merchant for offering mobile device based contactless payment transaction capabilities to its clients.

Step 602 comprises requesting from a terminal device communicably coupled with Kernel Server 414, registration of a merchant for services with Kernel Server 414. Pursuant to the request, step 604 comprises submitting to Kernel Server 414, merchant information required for registration.

Step 606 comprises selecting (based on user selection received at and communicated from the terminal device) from among a list of acquirers, an acquirer for providing acquirer services to the merchant. Step 606 further comprises generating and storing a data record mapping merchant information corresponding to the merchant with acquirer information corresponding to the selected acquirer.

At step 608, merchant registration data that is necessary for transaction execution may be optionally generated. Examples of such merchant data include a merchant identifier and/or a merchant category code intended to be associated with the registered merchant.

Step 610 comprises optionally configuring settings that enable the selected acquirer to communicate with any of (i) the Kernel Server 414, (ii) the merchant or a merchant server, and (iii) terminal devices (e.g. mobile devices) from which payment transaction requests corresponding to the merchant are intended to be received through Kernel Server 414 (e.g. callback URL settings).

Subsequent to completion of the merchant registration or onboarding process, step 610 may comprise transmitting confirmation of merchant registration to the terminal device from which the registration request was received.

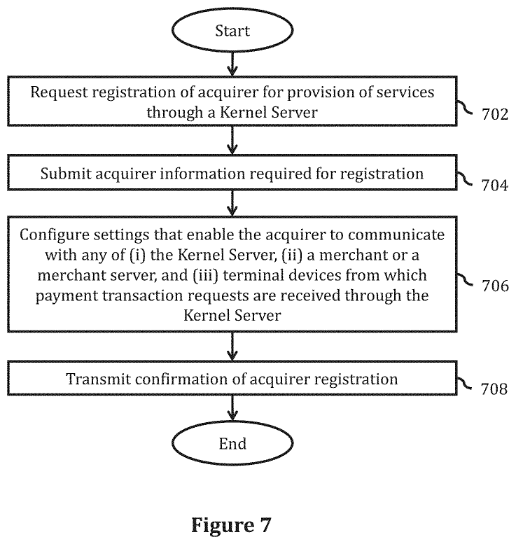

FIG. 7 is a flowchart illustrating a method for registering an acquirer for offering acquirer services to a merchant (who is registered for offering mobile device based contactless payment transaction capabilities to the merchant's clients).

Step 702 comprises requesting (at a terminal device communicably coupled with Kernel Server 414), registration of an acquirer for provision of services through Kernel Server 414. Pursuant to the request, step 704 comprises submitting from the terminal device, acquirer information required for registration.

Step 706 comprises configuring the Kernel Server (or settings therewithin) to enable the acquirer to communicate directly or indirectly with any of (i) the Kernel Server 414, (ii) a merchant or a merchant server, and (iii) terminal devices from which payment transaction requests are received through Kernel Server 414.

Step 708 may comprise transmitting to the terminal server from which the registration request was received, confirmation of completed acquirer registration.

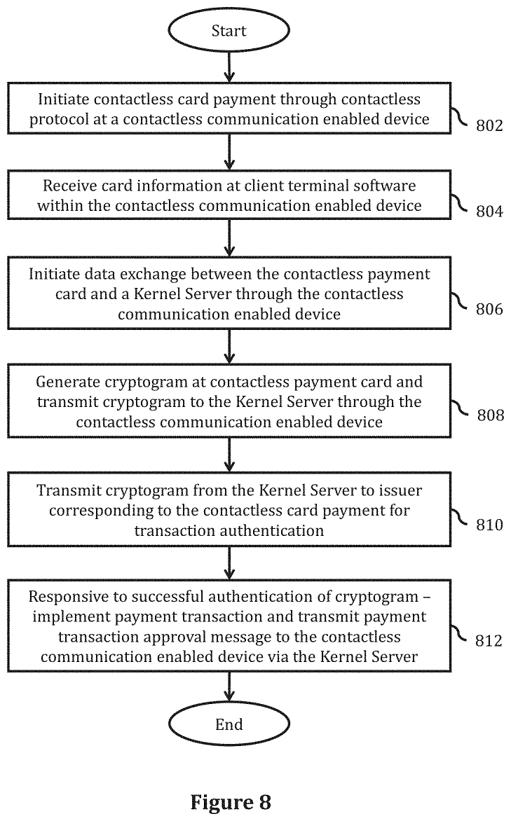

FIG. 8 is a flowchart illustrating a method for effecting a contactless payment transaction in accordance with the teachings of the present invention. In an embodiment, the method of FIG. 8 may be implemented within the system environment 400 of FIG. 4.

Step 802 comprises initiating contactless card based payment through a contactless communication protocol or near field communication protocol, at a processor implemented contactless communication enabled device/near field communication enabled device (for example a mobile device or computing device having contactless/NFC communication capability). In an embodiment, according to the present invention, step 802 is implemented by initiating a payment transaction based on wireless communication between contactless payment card 402 and mobile device 404—for example, by placing contactless payment card 404 in proximity with mobile device 404 for the purposes of initiating a payment transaction.

Step 804 comprises receiving card information at a client terminal software (for example, client terminal software 4060) within the processor implemented contactless communication enabled device/near field communication enabled device (e.g. mobile device 404)—which card information may be received from the contactless payment card at the processor implemented contactless communication enabled device/near field communication enabled device over a contactless communication protocol/near field communication protocol data channel established between the two.

Step 806 comprises initiating data exchange between the contactless payment card and an Kernel Server (for example, Kernel Server 414) through client terminal software implemented within the processor implemented contactless communication enabled device/near field communication enabled device. The data exchange may in an embodiment include transmitting to the Kernel Server, a request for implementing a payment transaction involving transfer of a payment amount (identified within received payment amount information) from a payment account associated with the contactless payment card to a payee account (identified by received payee account identifier information).

In an embodiment, the data (or the request for implementing the payment transaction) transmitted to the Kernel Server:
(i) is transmitted as part of one or more data messages that are in a format that is different from a format necessarily required by one or more of the payment network, acquirer network or issuer network for transaction processing or transaction authentication or transaction validation, or
(ii) is transmitted as part of one or more data messages that are in a message format that is non-compliant with or that is different from a predefined EMV message format that is necessarily required by one or more of the payment network, acquirer network or issuer network for transaction processing or transaction authentication or transaction validation, or
(iii) is transmitted as part of one or more data messages that omit or lack a certification (i.e. are uncertified) under one or more certification protocols that are necessarily required by one or more of the payment network, acquirer network or issuer network for transaction processing or transaction authentication or transaction validation, or
(iv) is transmitted as part of one or more data messages that omit or lack a certification (i.e. are uncertified) under one or more EMV certification protocols that are necessarily required by one or more of the payment network, acquirer network or issuer network for transaction processing or transaction authentication or transaction validation.

Based on the data exchange, the Kernel Server may communicate with an issuer server within an issuer network (for example, issuer network 410) associated with the contactless payment card (optionally through an acquirer server within an acquirer network (for example, acquirer network 408) associated with the payee account) to request implementation of the payment transaction.

In an embodiment, one or more of the data messages generated and transmitted by the Kernel Server to the issuer server:
(v) is transmitted as part of one or more data messages that are in a format that is compliant with a format necessarily required by one or more of the payment network, acquirer network or issuer network for transaction processing or transaction authentication or transaction validation, or
(vi) is transmitted as part of one or more data messages that are in a message format that is compliant with a predefined EMV message format that is necessarily required by one or more of the payment network, acquirer network or issuer network for transaction processing or transaction authentication or transaction validation, or
(vii) is transmitted as part of one or more data messages that include a certification (i.e. are certified) under one or more certification protocols that are necessarily required by one or more of the payment network, acquirer network or issuer network for transaction processing or transaction authentication or transaction validation, or
(viii) is transmitted as part of one or more data messages that include a certification (i.e. are certified) under one or more EMV certification protocols that are necessarily required by one or more of the payment network, acquirer network or issuer network for transaction processing or transaction authentication or transaction validation.

The issuer server may thereafter, for the purposes of transaction authentication, request a cryptogram from the contactless payment card—and this request may be transmitted from the issuer server to the acquirer server, through the Kernel Server to the processor implemented contactless communication enabled device/near field communication enabled device—and from the processor implemented contactless communication enabled device/near field communication enabled device to the contactless payment card.

Step 808 comprises generating a cryptogram at the contactless payment card, followed by transmission of the cryptogram to the Kernel Server through the client terminal software within the processor implemented contactless communication enabled device/near field communication enabled device. The cryptogram is a cryptogram that is generated such that it may be validated by an issuer or issuer network associated with the contactless payment card for ascertaining whether the payment transaction has been legitimately initiated by the contactless payment card.

Step 810 comprises transmitting the generated cryptogram from the Kernel Server onward to an issuer or issuer network corresponding to the contactless card payment for the purpose of identity authentication and/or transaction authorization.

Responsive to successful identity authentication and/or transaction authorization by the issuer or issuer network based on validation of the received cryptogram—step 812 comprises implementing the requested payment transaction and transmitting a payment transaction approval message (or payment confirmation message) to the processor implemented contactless communication enabled device/near field communication enabled device via the Kernel Server.

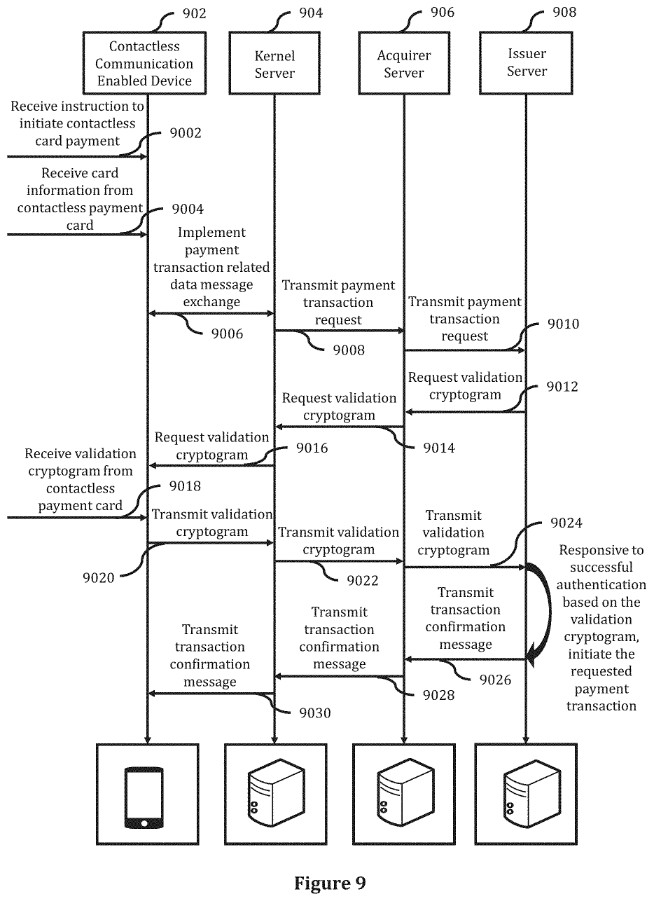

FIG. 9 is a communication flow diagram illustrating communication flow between system entities for implementing the method of FIG. 8.

Step 9002 comprises receiving at a processor implemented contactless communication enabled device/near field communication enabled device (or a software client terminal within said device) 902 having contactless communication and/or NFC communication capability, an instruction to initiate contactless card based payment. The device may comprise any computing device or mobile device having contactless communication capability/NFC communication capability, as well as network communication capability. The instruction may be received from a user or operator of the processor implemented contactless communication enabled device/near field communication enabled device 902 through a device user interface, or may alternatively be received from a software program or transaction platform that is being implemented on or accessed through the processor implemented contactless communication enabled device/near field communication enabled device 902. The instruction to initiate the contactless card based payment may include information identifying at least a payment amount, and optionally a payee account identifier. In a specific embodiment, step 9002 may be implemented, initiated or concluded by placing a contactless payment card in proximity with processor implemented contactless communication enabled device/near field communication enabled device 902 for the purposes of initiating a payment transaction.

Step 9004 comprises receiving at the processor implemented contactless communication enabled device/near field communication enabled device 902, payment card information corresponding to a contactless payment card that is intended to be used for the payment transaction. The payment card information may include at least a payment card identifier (for example, a payment card number or payment account number), and optionally one or more of an expiry date, card verification value (CVV) number and/or cardholder information associated with the contactless payment card. The payment card information at step 9004 may be transmitted from the contactless payment card to the processor implemented contactless communication enabled device/near field communication enabled device (or software client terminal within the processor implemented contactless communication enabled device/near field communication enabled device) 902 over a contactless communication channel or over a NFC communication channel.

Step 9006 comprises implementing a payment transaction related data message exchange session between the software client terminal within processor implemented contactless communication enabled device/near field communication enabled device 902 on one end and an Kernel Server 904 at the other end.

Thereafter, at step 9008, based on the data messages exchanged at step 9006, Kernel Server 904 transmits to acquirer server 906, a payment transaction request, comprising one or more of the received contactless payment card information, the payment amount, and the payee account identifier. The acquirer server 906 is a server controlled or operated by or on behalf of an acquirer institution at which the payee account is maintained.

At step 9010, the payment transaction request is transmitted onward from acquirer server 906 to an issuer server 908. The issuer server 908 is a server controlled or operated by or on behalf of an issuer institution at which a payment account or a payment card account associated with the contactless payment card is maintained.

At step 9012, issuer server 908 transmits back to acquirer server 906, a request for a validation cryptogram generated by the contactless payment card, to enable authentication of the received payment transaction request. The request for a validation cryptogram is transmitted at step 9014 from acquirer server 906 to Kernel Server 904, and at step 9016 is further transmitted by Kernel Server 904 to the software client terminal within the processor implemented contactless communication enabled device/near field communication enabled device 902.

The software client terminal within the processor implemented contactless communication enabled device/near field communication enabled device 902 thereafter communicates with the contactless payment card over the contactless communication channel/NFC communication channel and at step 9018 receives from the contactless payment card, a validation cryptogram generated by the contactless payment card.

At step 9020, the validation cryptogram is transmitted by the software client terminal within the processor implemented contactless communication enabled device/near field communication enabled device 902 to the Kernel Server 904. At step 9022, Kernel Server 904 transmits the validation cryptogram to acquirer server 906, and at step 9024, acquirer server 906 transmits the validation cryptogram to issuer server 908.

Upon receiving the validation cryptogram, issuer server 908 verifies the received validation cryptogram. Responsive to successful authentication or verification of the validation cryptogram, issuer server 908 initiates the requested payment transaction involving transfer of the payment amount from a payment account associated with the contactless payment card to the payee account.

Step 9026 comprises transmitting a transaction confirmation message from the issuer server 908 to the acquirer server 906. Step 9028 comprises transmitting the transaction confirmation message onward from the acquirer server 906 to the Kernel Server 904, and step 9030 further comprises transmitting the transaction confirmation message from the Kernel Server 904 to the software client terminal within the processor implemented contactless communication enabled device/near field communication enabled device 902.

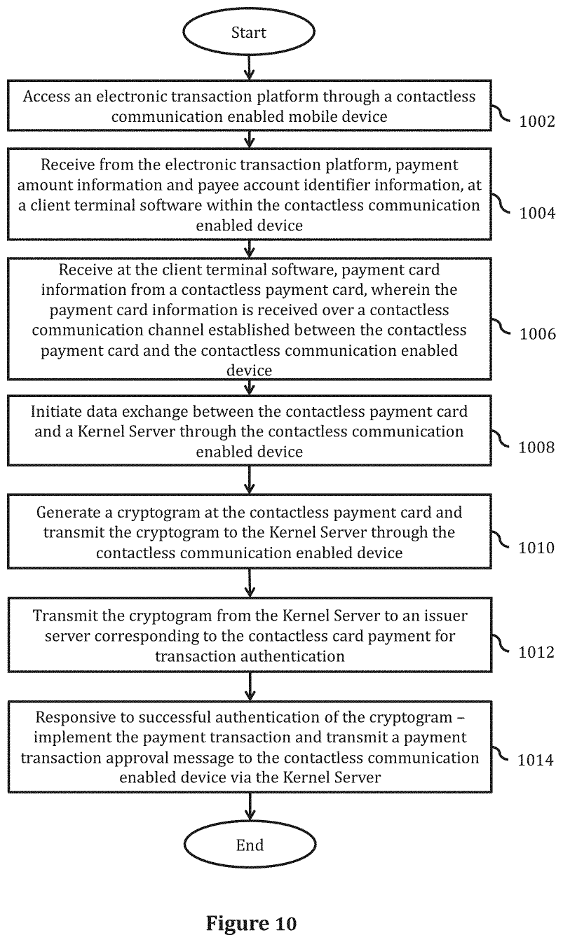

FIG. 10 is a flowchart illustrating a method for effecting a processor implemented contactless communication enabled device/near field communication enabled device based contactless payment transaction through an electronic transaction platform, in accordance with the teachings of the present invention. In an embodiment, the method of FIG. 10 may be implemented for the purposes of enabling a user who is accessing an electronic transaction platform (such as an e-commerce platform) from a mobile device or a computing device, to transmit payment of a payment amount to a payment account associated with or identified by the electronic transaction platform, using a contactless payment card and using the contactless communication capability/NFC communication capability of said processor implemented contactless communication enabled device/near field communication enabled device. In an embodiment, the method of FIG. 10 may be implemented within the system environment 400 of FIG. 4.

Step 1002 comprises accessing an electronic transaction platform (for example an electronic commerce platform, or any other network communication enabled platform that enables payment for products or services) through a processor implemented contactless communication enabled device/near field communication enabled device (for example a contactless communication/NFC communication enabled mobile device or computing device). In an embodiment, the processor implemented contactless communication enabled device/near field communication enabled device is mobile device 404.

Step 1004 comprises receiving from the electronic transaction platform, a payment amount information and payee account identifier information, at a client terminal software within the processor implemented contactless communication enabled device/near field communication enabled device.

Step 1006 comprises receiving at the client terminal software, payment card information from a contactless payment card (for e.g. contactless payment card 402) having contactless communication and/or NFC communication capability, wherein the payment card information is received over a contactless communication channel established between the contactless payment card and the processor implemented contactless communication enabled device/near field communication enabled device.

Step 1008 comprises initiating data exchange between the contactless payment card and a Kernel Server (for example, Kernel Server 414) through the client terminal software within the processor implemented contactless communication enabled device/near field communication enabled device. The data exchange may in an embodiment include transmitting to the Kernel Server, a request for implementing a payment transaction involving transfer of a payment amount (identified within the received payment amount information) from a payment account associated with the contactless payment card to a payee account (identified by the received payee account identifier information).

The data exchange may in an embodiment include transmitting to the Kernel Server, a request for implementing a payment transaction involving transfer of a payment amount (identified within received payment amount information) from a payment account associated with the contactless payment card to the payee account (identified by the received payee account identifier information).

In an embodiment, the data transmitted to the Kernel Server from the client terminal software within the processor implemented contactless communication enabled device/near field communication enabled device:
(i) is transmitted as part of one or more data messages that are in a format that is different from a format necessarily required by one or more of the payment network, acquirer network or issuer network for transaction processing or transaction authentication or transaction validation, or
(ii) is transmitted as part of one or more data messages that are in a message format that is non-compliant with or that is different from a predefined EMV message format that is necessarily required by one or more of the payment network, acquirer network or issuer network for transaction processing or transaction authentication or transaction validation, or
(iii) is transmitted as part of one or more data messages that omit or lack a certification (i.e. are uncertified) under one or more certification protocols that are necessarily required by one or more of the payment network, acquirer network or issuer network for transaction processing or transaction authentication or transaction validation, or
(iv) is transmitted as part of one or more data messages that omit or lack a certification (i.e. are uncertified) under one or more EMV certification protocols that are necessarily required by one or more of the payment network, acquirer network or issuer network for transaction processing or transaction authentication or transaction validation.

Based on the data exchange, the Kernel Server may communicate with an issuer server within an issuer network (for example, issuer network 410) associated with the contactless payment card (optionally through an acquirer server within an acquirer network associated with the payee account) to request implementation of the payment transaction. The issuer server may thereafter, for the purposes of transaction authentication, request a cryptogram from the contactless payment card—and this request may be transmitted from the issuer server to the acquirer server, through the Kernel Server to the processor implemented contactless communication enabled device/near field communication enabled device—and from said device to the contactless payment card.

In an embodiment, the request for implementation of a payment request that is transmitted by the Kernel Server to the issuer server:
(i) is transmitted as part of one or more data messages that are in a format that is compliant with a format necessarily required by one or more of the payment network, acquirer network or issuer network for transaction processing or transaction authentication or transaction validation, or
(ii) is transmitted as part of one or more data messages that are in a message format that is compliant with a predefined EMV message format that is necessarily required by one or more of the payment network, acquirer network or issuer network for transaction processing or transaction authentication or transaction validation, or
(iii) is transmitted as part of one or more data messages that include a certification (i.e. are certified) under one or more certification protocols that are necessarily required by one or more of the payment network, acquirer network or issuer network for transaction processing or transaction authentication or transaction validation, or
(iv) is transmitted as part of one or more data messages that include a certification (i.e. are certified) under one or more EMV certification protocols that are necessarily required by one or more of the payment network, acquirer network or issuer network for transaction processing or transaction authentication or transaction validation.

Thereafter, step 1010 comprises generating a cryptogram at the contactless payment card and transmitting the generated cryptogram to the Kernel Server through client terminal software within the processor implemented contactless communication enabled device/near field communication enabled device. The cryptogram is a cryptogram that is generated such that it may be validated by an issuer or issuer network associated with the contactless payment card for ascertaining whether the payment transaction has been legitimately initiated by the contactless payment card.

Step 1012 involves transmitting the generated cryptogram from the Kernel Server to the issuer server within the issuer network associated with the contactless payment card (optionally through the acquirer server within the acquirer network associated with the payee account).

Upon receiving the cryptogram, the issuer server verifies the received cryptogram. At step 1014, responsive to successful authentication of cryptogram—the issuer server implements the requested payment transaction and transmits a payment transaction approval message to the processor implemented contactless communication enabled device/near field communication enabled device via the Kernel Server.

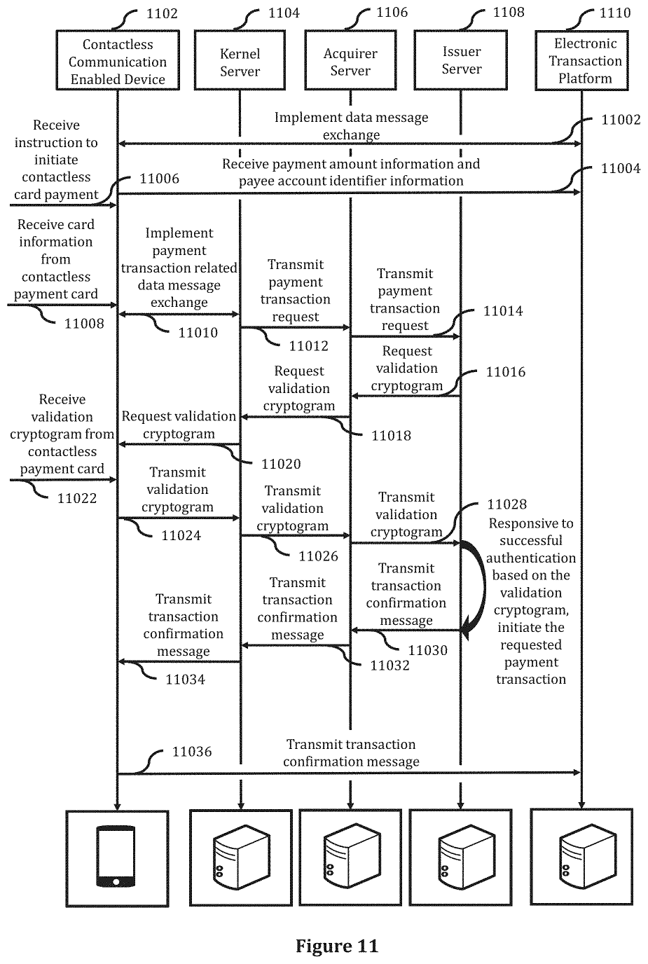

FIG. 11 is a communication flow diagram illustrating communication flow between system entities for implementing the method of FIG. 10.

Step 11002 comprises implementing a data message exchange or data message communication session between a processor implemented contactless communication enabled device/near field communication enabled device (or a software client terminal within said device) 1102 and an electronic transaction platform 1110 (for example an e-commerce platform or a merchant purchase platform) that is being implemented on or accessed through the mobile device/computing device 1102. In an embodiment, processor implemented contactless communication enabled device/near field communication enabled device 1102 is a mobile device or a computing device having contactless communication and/or NFC communication capability.

Step 11004 comprises receiving at the processor implemented contactless communication enabled device/near field communication enabled device 1102, an instruction to initiate a contactless card based payment. The instruction may in an embodiment be received from the electronic transaction platform 1110. The instruction to initiate the contactless card based payment may include information identifying at least a payment amount, and optionally a payee account identifier.

Step 11006 comprises receiving at the processor implemented contactless communication enabled device/near field communication enabled device 1102, an instruction to initiate a contactless card payment. The instruction may be received from a user through a user interface implemented within the processor implemented contactless communication enabled device/near field communication enabled device (or at software client terminal within said device) 1102. In another embodiment, said instruction may be detected or received as a result of a contactless payment card being placed in proximity with the processor implemented contactless communication enabled device/near field communication enabled device, for the purposes of initiating a payment transaction.

Step 11008 comprises receiving at the processor implemented contactless communication enabled device/near field communication enabled device (or at the software client terminal within said device) 1102, payment card information corresponding to a contactless payment card that is intended to be used for the payment transaction. The payment card information may include at least a payment card identifier (for example, a payment card number or payment account number), and optionally one or more of an expiry date, card verification value (CVV) number and/or cardholder information associated with the contactless payment card. The payment card information at step 11008 may be transmitted from the contactless payment card to the processor implemented contactless communication enabled device/near field communication enabled device (or software client terminal within said device) 1102 over a contactless communication channel or over a NFC communication channel.

Step 11010 comprises implementing a payment transaction related data message exchange session between the software client terminal within the processor implemented contactless communication enabled device/near field communication enabled device (or software client terminal within said device) 1102 on one end and Kernel Server 1104 at the other end.

Thereafter, at step 11012, based on the data messages exchanged at step 11010, Kernel Server 1104 transmits to acquirer server 1106, a payment transaction request, comprising one or more of the received contactless payment card information, the payment amount, and the payee account identifier. The acquirer server 1106 may comprise a server controlled or operated by or on behalf of an acquirer institution at which the payee account is maintained.

At step 11014, the payment transaction request is transmitted onward from the acquirer server 1106 to an issuer server 1108. The issuer server 1108 may comprise a server controlled or operated by or on behalf of an issuer institution at which a payment account or a payment card account associated with the contactless payment card is maintained.

At step 11016, the issuer server 1108 transmits back to the acquirer server 1106, a request for a validation cryptogram generated by the contactless payment card, to enable authentication of the received payment transaction request. The request for a validation cryptogram is transmitted at step 11018 from the acquirer server 1106 to the Kernel Server 1104, and at step 11020 is further transmitted by the Kernel Server 1104 to the processor implemented contactless communication enabled device/near field communication enabled device (or the software client terminal within said device) 1102.

The processor implemented contactless communication enabled device/near field communication enabled device (or software client terminal within said device) 1102 thereafter communicates with the contactless payment card over the contactless communication channel/NFC communication channel and at step 11022 receives from the contactless payment card, a validation cryptogram generated by the contactless payment card.

At step 11024, the validation cryptogram is transmitted by the processor implemented contactless communication enabled device/near field communication enabled device (or software client terminal within said device) 1102 to the Kernel Server 1104. At step 11026, the Kernel Server 1104 transmits the validation cryptogram to the acquirer server 1106, and at step 11028, the acquirer server 1106 transmits the validation cryptogram to the issuer server 1108.

Upon receiving the validation cryptogram, the issuer server 1108 verifies the received validation cryptogram. Responsive to successful authentication or verification of the validation cryptogram, the issuer server 1108 initiates the requested payment transaction involving transfer of the payment amount from a payment account associated with the contactless payment card to the payee account.

Step 11030 comprises transmitting a transaction confirmation message from the issuer server 1108 to the acquirer server 1106. Step 11032 comprises transmitting the transaction confirmation message onward from the acquirer server 1106 to the Kernel Server 1104, and step 11034 further comprises transmitting the transaction confirmation message from the Kernel Server 1104 to the processor implemented contactless communication enabled device/near field communication enabled device (or software client terminal within said device) 1102. Step 11036 comprises transmitting a data message from the processor implemented contactless communication enabled device/near field communication enabled device (or software client terminal within said device) 1102 to the electronic transaction platform 1110, confirming that the requested transaction payment has been successfully concluded.

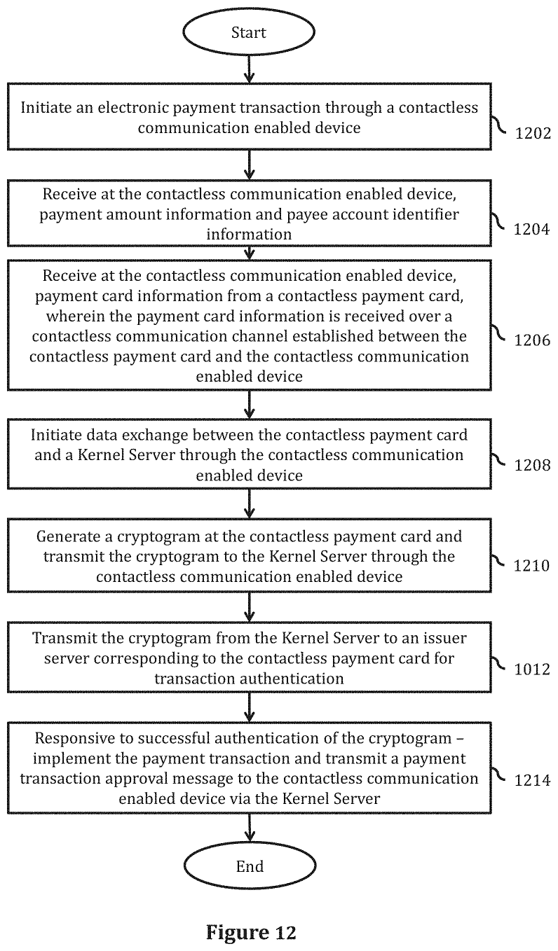

FIG. 12 is a flowchart illustrating a method for effecting a contactless payment transaction through a merchant device, in accordance with the teachings of the present invention. In an embodiment, the method of FIG. 12 may be implemented within the system environment 400 of FIG. 4.

Step 1202 comprises initiating an electronic payment transaction through a processor implemented contactless communication enabled device/near field communication enabled device having contactless communication capability/NFC communication capability as well as network communication capability (or through a client terminal software installed on such processor implemented contactless communication enabled device/near field communication enabled device), In specific embodiments, the processor implemented contactless communication enabled device/near field communication enabled device may comprise a mobile device or a computing device having contactless communication capability/NFC protocol based communication capability, or may comprise a dedicated internet-of-things (IOT) device having contactless communication capability/NFC protocol based communication capability and network communication capability. In a particular embodiment, the processor implemented contactless communication enabled device/near field communication enabled device may comprise a mobile device or computing device or IOT device available at a merchant location, wherein customers seeking to make a purchase or a transaction at the merchant location, may use the merchant device for making the transaction payment.

The instruction for initiating the electronic payment transaction may be received from a user or operator of the processor implemented contactless communication enabled device/near field communication enabled device through a device user interface, or may alternatively be received from a software program or transaction platform that is being implemented on or accessed through the processor implemented contactless communication enabled device/near field communication enabled device. In an embodiment, according to the present invention, step 1202 may be implemented by initiating a payment transaction based on wireless communication between a contactless payment card (for example, contactless payment card 402) and processor implemented contactless communication enabled device/near field communication enabled device (for example, mobile device 404)—for example, by placing the contactless payment card in proximity with the processor implemented contactless communication enabled device/near field communication enabled device for the purposes of initiating a payment transaction.

Step 1204 comprises receiving at the processor implemented contactless communication enabled device/near field communication enabled device or at the client terminal software within said processor implemented contactless communication enabled device/near field communication enabled device, payment amount information and payee account identifier information.

Step 1206 comprises receiving at the processor implemented contactless communication enabled device/near field communication enabled device or the client terminal software therewithin, payment card information from a contactless payment card, wherein the payment card information is received over a contactless communication channel established between the contactless payment card and the processor implemented contactless communication enabled device/near field communication enabled device. The payment card information may include at least a payment card identifier (for example, a payment card number or payment account number), and optionally one or more of an expiry date, card verification value (CVV) number and/or cardholder information associated with the contactless payment card. The payment card information at step 1206 may be transmitted from the contactless payment card to the processor implemented contactless communication enabled device/near field communication enabled device (or to the software client terminal therewithin) over a contactless communication channel or over a NFC communication channel.

Step 1208 comprises initiating a data exchange between the contactless payment card and an Kernel Server (for example, Kernel Server 414) through the processor implemented contactless communication enabled device/near field communication enabled device or through the client terminal software within the said device. The data exchange may in an embodiment include transmitting to the Kernel Server, a request for implementing a payment transaction involving transfer of a payment amount (identified within received payment amount information) from a payment account associated with the contactless payment card to a payee account (identified by received payee account identifier information).

In an embodiment, the data (or the request for implementing the payment transaction) transmitted from the processor implemented contactless communication enabled device/near field communication enabled device (or through the client terminal software within the said device) to the Kernel Server:
(v) is transmitted as part of one or more data messages that are in a format that is different from a format necessarily required by one or more of the payment network, acquirer network or issuer network for transaction processing or transaction authentication or transaction validation, or
(vi) is transmitted as part of one or more data messages that are in a message format that is non-compliant with or that is different from a predefined EMV message format that is necessarily required by one or more of the payment network, acquirer network or issuer network for transaction processing or transaction authentication or transaction validation, or
(vii) is transmitted as part of one or more data messages that omit or lack a certification (i.e. are uncertified) under one or more certification protocols that are necessarily required by one or more of the payment network, acquirer network or issuer network for transaction processing or transaction authentication or transaction validation, or
(viii) is transmitted as part of one or more data messages that omit or lack a certification (i.e. are uncertified) under one or more EMV certification protocols that are necessarily required by one or more of the payment network, acquirer network or issuer network for transaction processing or transaction authentication or transaction validation.

Based on the data exchange, the Kernel Server may communicate with an issuer server within an issuer network (for example issuer network 410) associated with the contactless payment card (optionally through an acquirer server within an acquirer network—for example, acquirer network 408 associated with the payee account) to request implementation of the payment transaction.

In an embodiment, one or more of the data messages generated and transmitted by the Kernel Server to the issuer server:
(v) is transmitted as part of one or more data messages that are in a format that is compliant with a format necessarily required by one or more of the payment network, acquirer network or issuer network for transaction processing or transaction authentication or transaction validation, or
(vi) is transmitted as part of one or more data messages that are in a message format that is compliant with a predefined EMV message format that is necessarily required by one or more of the payment network, acquirer network or issuer network for transaction processing or transaction authentication or transaction validation, or
(vii) is transmitted as part of one or more data messages that include a certification (i.e. are certified) under one or more certification protocols that are necessarily required by one or more of the payment network, acquirer network or issuer network for transaction processing or transaction authentication or transaction validation, or
(viii) is transmitted as part of one or more data messages that include a certification (i.e. are certified) under one or more EMV certification protocols that are necessarily required by one or more of the payment network, acquirer network or issuer network for transaction processing or transaction authentication or transaction validation.

The issuer server may thereafter, for the purposes of transaction authentication, request a validation cryptogram from the contactless payment card—and this request may be transmitted from the issuer server to the acquirer server, through the Kernel Server to the processor implemented contactless communication enabled device/near field communication enabled device—and from said device to the contactless payment card.

Step 1210 comprises generating a validation cryptogram at the contactless payment card and transmitting the validation cryptogram to the Kernel Server through the processor implemented contactless communication enabled device/near field communication enabled device or through the client terminal software within said device. The validation cryptogram is a cryptogram that is generated such that it may be validated by an issuer server or issuer network associated with contactless payment card, for ascertaining whether the payment transaction has been legitimately initiated by the contactless payment card.

Step 1212 comprises transmitting the validation cryptogram from the Kernel Server to the issuer server—for the purpose of identity authentication and/or transaction authorization.

At step 1214, responsive to successful authentication of the validation cryptogram by the issuer server or issuer network, the payment transaction is implemented or executed by the issuer server, and a payment transaction approval/confirmation message is transmitted by the issuer server to the processor implemented contactless communication enabled device/near field communication enabled device via the Kernel Server (for example, Kernel Server 414).

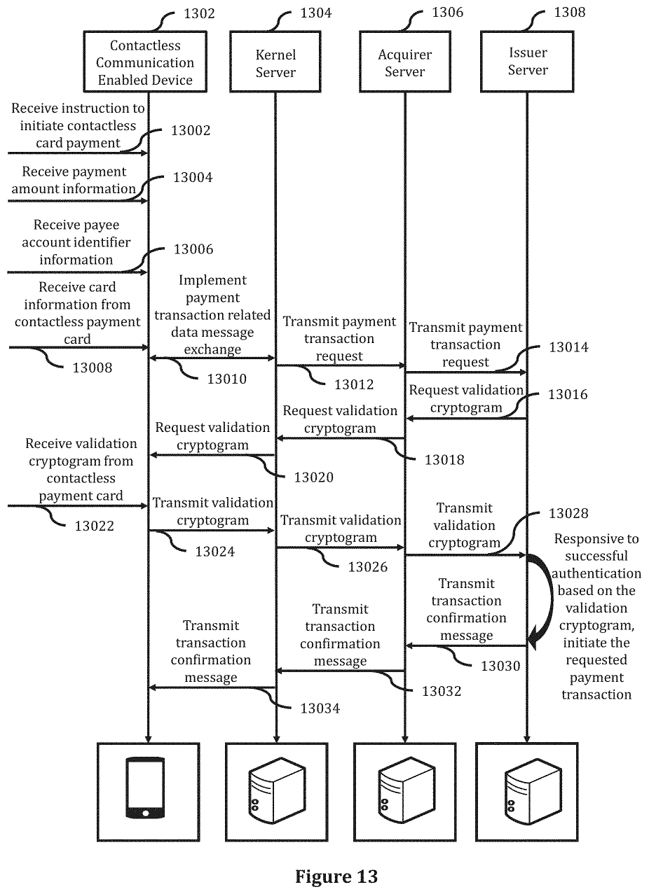

FIG. 13 is a communication flow diagram illustrating communication flow between system entities for implementing the method of FIG. 12.

Step 13002 comprises receiving at a processor implemented contactless communication enabled device/near field communication enabled device (or a software client terminal within the device) 1302 having contactless communication and/or NFC communication capability, an instruction to initiate contactless card based payment. The instruction may be received from a user or operator of the processor implemented contactless communication enabled device/near field communication enabled device 1302 through a device user interface, or may alternatively be received from a software program or transaction platform that is being implemented on or accessed through said device 1302. In a particular embodiment, the processor implemented contactless communication enabled device/near field communication enabled device may comprise a mobile device or computing device available at a merchant location, wherein customers seeking to make a purchase or a transaction at the merchant location, may use the merchant's processor implemented contactless communication enabled device/near field communication enabled device for making the transaction payment. The instruction to initiate the contactless card based payment may include information identifying at least a payment amount, and optionally a payee account identifier. In a specific embodiment, step 13002 may be implemented, initiated or concluded by placing a contactless payment card in proximity with the processor implemented contactless communication enabled device/near field communication enabled device 1302 for the purposes of initiating a payment transaction.

Step 13004 comprises receiving at the processor implemented contactless communication enabled device/near field communication enabled device 1302, payment amount information identifying a payment amount which is intended to be transferred through the electronic payment transaction. Step 13006 comprises receiving at the processor implemented contactless communication enabled device/near field communication enabled device 1302, payee account identifier information, which enables identification of a payee account to which the payment amount is intended to be transferred through the electronic payment transaction. In an embodiment, the payee account identifier information may be pre-stored within the merchant's contactless communication enabled device and may be retrieved or received from a memory or storage within the merchant's processor implemented contactless communication enabled device/near field communication enabled device, for the purposes of step 13006.

Step 13008 comprises receiving at the processor implemented contactless communication enabled device/near field communication enabled device 1302, payment card information corresponding to a contactless payment card that is intended to be used for the payment transaction. The payment card information may include at least a payment card identifier (for example, a payment card number or payment account number), and optionally one or more of an expiry date, card verification value (CVV) number and/or cardholder information associated with the contactless payment card. The payment card information at step 13008 may be transmitted from the contactless payment card to the processor implemented contactless communication enabled device/near field communication enabled device (or to the software client terminal within the device) 1302 over a contactless communication channel or over a NFC communication channel.

Step 13010 comprises implementing a payment transaction related data message exchange session between the processor implemented contactless communication enabled device/near field communication enabled device (or the software client terminal within the contactless communication enabled device) 1302 on one end and an Kernel Server 1304 at the other end.

Thereafter, at step 13012, based on the data messages exchanged at step 13010, the Kernel Server 1304 transmits to an acquirer server 1306, a payment transaction request, comprising one or more of the received contactless payment card information, the payment amount, and the payee account identifier. The acquirer server 1306 may comprise a server controlled or operated by or on behalf of an acquirer institution at which the payee account is maintained.

At step 13014, the payment transaction request is transmitted onward from the acquirer server 1306 to an issuer server 1308. The issuer server 1308 may comprise a server controlled or operated by or on behalf of an issuer institution at which a payment account or a payment card account associated with the contactless payment card is maintained.

At step 13016, the issuer server 1308 transmits back to the acquirer server 1306, a request for a validation cryptogram generated by the contactless payment card, to enable authentication of the received payment transaction request. The request for a validation cryptogram is transmitted at step 13018 from the acquirer server 1306 to the Kernel Server 1304, and at step 13020 is further transmitted by the Kernel Server 1304 to the processor implemented contactless communication enabled device/near field communication enabled device (or to the software client terminal within said device) 1302.

The processor implemented contactless communication enabled device/near field communication enabled device (or the software client terminal within said device) 1302 thereafter communicates with the contactless payment card over the contactless communication channel/NFC communication channel and at step 13022 receives from the contactless payment card, a validation cryptogram generated by the contactless payment card.

At step 13024, the validation cryptogram is transmitted by processor implemented contactless communication enabled device/near field communication enabled device (or the software client terminal within said device) 1302 to the Kernel Server 1304. At step 13026, the Kernel Server 1304 transmits the validation cryptogram to the acquirer server 1306, and at step 13028, the acquirer server 1306 transmits the validation cryptogram to the issuer server 1308.

Upon receiving the validation cryptogram, the issuer server 1308 verifies the received validation cryptogram. Responsive to successful authentication or verification of the validation cryptogram, the issuer server 1308 initiates the requested payment transaction involving transfer of the payment amount from a payment account associated with the contactless payment card to the payee account.

Step 13030 comprises transmitting a transaction confirmation message from the issuer server 1308 to the acquirer server 1306. Step 13032 comprises transmitting the transaction confirmation message onward from the acquirer server 1306 to the Kernel Server 1304, and step 13034 further comprises transmitting the transaction confirmation message from the Kernel Server 1304 to the processor implemented contactless communication enabled device/near field communication enabled device (or the software client terminal within said device) 1302.

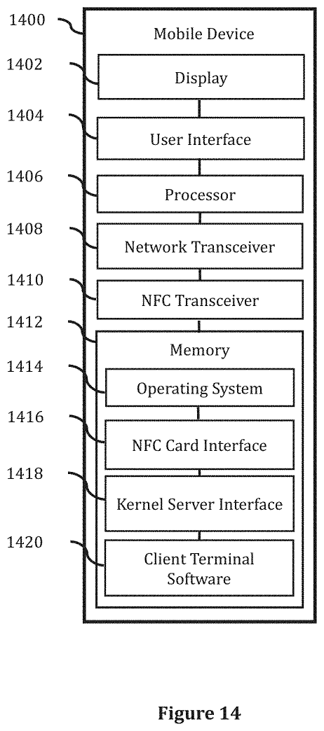

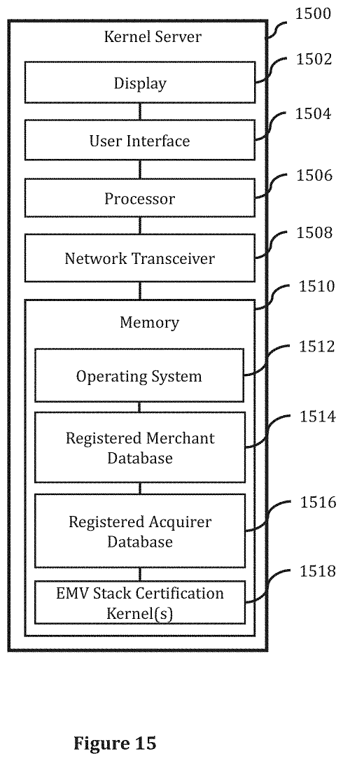

FIG. 14 illustrates a mobile device 1400 of a type illustrated and described more generally in connection with FIGS. 4 and 5 above, which may be configured for contactless payment transaction implementation in accordance with the teachings of the present invention. Mobile device 1400 may be configured to be communicably coupled to a Kernel Server (for example, to Kernel Server 1500 of FIG. 15) through a communication network.

Mobile device 1400 comprises display 1402, a user interface 1404, processor 1406, a network transceiver 1408 configured for enabling data network based communication, a NFC transceiver 1410 configured for enabling near field communication protocol based communications, and memory 1412—which memory 1412 may include transitory memory and/or non-transitory memory. In an exemplary embodiment, memory 1412 may have stored therewithin, (i) an operating system 1414 configured for managing device hardware and software resources and that provides common services for software programs implemented within mobile device 1400, (ii) NFC card interface 1416 comprising a processor controlled interface configured to enable mobile device 1400 to interface with one or more contactless payment cards having near field communication capabilities, based on near field communication protocol(s), (iii) Kernel Server interface 1418 comprising a processor controlled interface configured to enable mobile device 1400 to interface with a Kernel Server over a data network, and (iv) client terminal software 1420 comprising software application files or SDK files stored in mobile device 1400 which may be configured to enable the above described functionality of one or more of network transceiver 1408, NFC transceiver 1410, NFC card interface 1416 and Kernel Server interface 1418.

The mobile device illustrated and described in connection with FIG. 14 may be configured to implement one or more of the methods discussed in more detail below in connection with FIGS. 6 to 8 and/or the communication flow diagram of FIG. 9.

FIG. 15 illustrates a Kernel Server 1500 of a type illustrated and described more generally in connection with FIGS. 4 and 5 above, which may be configured for enabling contactless payment transaction implementation in accordance with the teachings of the present invention. Kernel Server 1500 may be configured to be communicably coupled to a mobile device (for example, to mobile device 1400 of FIG. 14) through a communication network.

Kernel Server 1500 comprises display 1502, a user interface 1504, processor 1506, a network transceiver 1508 configured for enabling data network based communication, and memory 1510—which memory 1510 may include transitory memory and/or non-transitory memory. In an exemplary embodiment, memory 1510 may have stored therewithin, (i) an operating system 1512 configured for managing device hardware and software resources and that provides common services for software programs implemented within Kernel Server 1500, (ii) a registered merchant database 1514 configured to retrievably store information corresponding to merchants that are onboarded or registered for utilizing the functionality of Kernel Server 1500 for enabling customers to make mobile device based near field communication payments using a contactless payment card, (iii) a registered acquirer database 1516 configured to retrievably store information corresponding to acquirers that are onboarded or registered for providing payment account services to merchants who are utilizing the functionality of Kernel Server 1500, for enabling customers to make mobile device based near field communication payments using a contactless payment card, and (iv) EMV stack certification kernel(s) 1518 comprising one or more a processor controlled kernels configured to (a) enable secure data communication between Kernel Server 1500 and a mobile device (for example, mobile device 1400), and/or (b) enable Kernel Server 1500 to communicate with one or more of payment networks, acquirer networks and issuer networks based on the EMV standard communication protocols for the purposes of implementing electronic payment card based transactions.

The Kernel Server illustrated and described in connection with FIG. 15 may be configured to implement one or more of the methods discussed in more detail below in connection with FIGS. 6 to 8 and/or the communication flow diagram of FIG. 9.

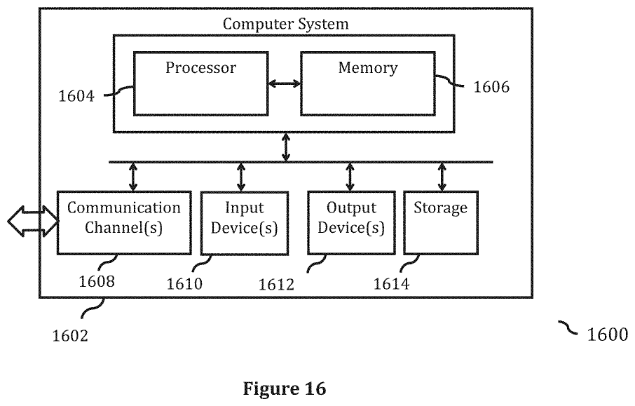

FIG. 16 illustrates an exemplary computer system 1600 according to which various embodiments of the present invention may be implemented.

System 1600 includes computer system 1602 which in turn comprises one or more processors 1604 and at least one memory 1606. Processor 1604 is configured to execute program instructions—and may be a real processor or a virtual processor. It will be understood that computer system 1602 does not suggest any limitation as to scope of use or functionality of described embodiments. The computer system 1602 may include, but is not limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 1602 in accordance with the present invention may include one or more servers, desktops, laptops, tablets, smart phones, mobile phones, mobile communication devices, phablets and personal digital assistants. In an embodiment of the present invention, the memory 1606 may store software for implementing various embodiments of the present invention. The computer system 1602 may have additional components. For example, the computer system 1602 may include one or more communication channels 1608, one or more input devices 1610, one or more output devices 1612, and storage 1614. An interconnection mechanism (not shown) such as a bus, controller, or network, interconnects the components of the computer system 1602. In various embodiments of the present invention, operating system software (not shown) provides an operating environment for various softwares executing in the computer system 1602 using a processor 1604, and manages different functionalities of the components of the computer system 1602.

The communication channel(s) 1608 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 1610 may include, but is not limited to, a touch screen, a keyboard, mouse, pen, joystick, trackball, a voice device, a scanning device, or any another device that is capable of providing input to the computer system 1602. In an embodiment of the present invention, the input device(s) 1610 may be a sound card or similar device that accepts audio input in analog or digital form. The output device(s) 1612 may include, but not be limited to, a user interface on CRT, LCD, LED display, or any other display associated with any of servers, desktops, laptops, tablets, smart phones, mobile phones, mobile communication devices, phablets and personal digital assistants, printer, speaker, CD/DVD writer, or any other device that provides output from the computer system 1602.

The storage 1614 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 1602. In various embodiments of the present invention, the storage 1614 may contain program instructions for implementing any of the described embodiments.

In an embodiment of the present invention, the computer system 1602 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 1602. The method described herein is typically implemented as a computer program product, comprising a set of program instructions that is executed by the computer system 1602 or any other similar device. The set of program instructions may be a series of computer readable codes stored on a tangible medium, such as a computer readable storage medium (storage 1614), for example, diskette, CD-ROM, ROM, flash drives or hard disk, or transmittable to the computer system 1602, via a modem or other interface device, over either a tangible medium, including but not limited to optical or analogue communications channel(s) 1608. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

Based on the above, it will be understood that the present invention provides solutions for enabling contactless payment card based transactions for payment transactions being implemented through contactless communication enabled devices such as mobile devices. The solutions of the present invention enables automated, secure and correct input of card information, and payor authentication information—which increases both convenience and user friendliness.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclose herein suitably may be practiced in the absence of any element which is not specifically disclosed herein—and in a particular embodiment that is specifically contemplated, the invention is intended to be practiced in the absence of any one or more element which are not specifically disclosed herein.

1. A system for implementing a contactless payment card based payment transaction comprising at least one processor implemented contactless communication enabled device configured for contactless communication and for network communication, and configured for:
establishing a contactless communication protocol based data channel with a contactless payment card through the at least one processor implemented contactless communication enabled device;
receiving payment card information from the contactless payment card over the contactless communication protocol based data channel;
transmitting to a kernel server, a payment transaction request for onward transmission to an issuer server associated with the contactless payment card, the payment transaction request identifying a payment amount, a payee account, and payment account associated with the contactless payment card;
receiving from the kernel server, a validation cryptogram request, wherein the validation cryptogram request has been generated by the issuer server; and
transmitting the validation cryptogram from the contactless payment card to the kernel server, for onward transmission to the issuer server.

2. The system as claimed in claim 1, wherein:
the kernel server is certified for implementing a set of communication protocols that enable implementation of the payment transaction through the issuer server; or
the contactless communication enabled device is uncertified for implementing the set of communication protocols that enable implementation of the payment transaction through the issuer server.

3. The system as claimed in claim 1:
wherein the payment transaction request transmitted to the kernel server:
is transmitted as part of one or more data messages that are in a format that is different from a format necessarily required by one or more of the payment network, acquirer network or issuer network for transaction processing or transaction authentication or transaction validation, or
is transmitted as part of one or more data messages that are in a message format that is non-compliant with or that is different from a predefined Europay-Mastercard-Visa (EMV) message format that is necessarily required by one or more of the payment network, acquirer network or issuer network for transaction processing or transaction authentication or transaction validation, or
is transmitted as part of one or more data messages that is uncertified under one or more certification protocols that are necessarily required by one or more of the payment network, acquirer network or issuer network for transaction processing or transaction authentication or transaction validation, or
is transmitted as part of one or more data messages that are uncertified under one or more EMV certification protocols that are necessarily required by one or more of the payment network, acquirer network or issuer network for transaction processing or transaction authentication or transaction validation;
and wherein the kernel server is configured to transmit the payment transaction request onward to the issuer server, such that said onward transmitted payment transaction request:
is transmitted as part of one or more data messages that are in a format that is compliant with a format necessarily required by one or more of the payment network, acquirer network or issuer network for transaction processing or transaction authentication or transaction validation, or
is transmitted as part of one or more data messages that are in a message format that is compliant with the predefined EMV message format that is necessarily required by one or more of the payment network, acquirer network or issuer network for transaction processing or transaction authentication or transaction validation, or
is transmitted as part of one or more data messages that are certified under one or more certification protocols that are necessarily required by one or more of the payment network, acquirer network or issuer network for transaction processing or transaction authentication or transaction validation, or
is transmitted as part of one or more data messages that are certified under one or more EMV certification protocols that are necessarily required by one or more of the payment network, acquirer network or issuer network for transaction processing or transaction authentication or transaction validation.

4. The system as claimed in claim 1, wherein the kernel server is configured to:
establish at least one additional contactless communication protocol based data channel with at least one additional contactless payment card through an additional processor implemented contactless communication enabled device;
receive payment card information from the additional contactless payment card over the additional contactless communication protocol based data channel;
receive an additional payment transaction request for onward transmission to an additional issuer server associated with the additional contactless payment card, the additional payment transaction request identifying an additional payment amount, an additional payee account, and additional payment account associated with the additional contactless payment card;
receive an additional validation cryptogram request, wherein the additional validation cryptogram request has been generated by the issuer server; and
receive the additional validation cryptogram from the additional contactless payment card, for onward transmission to the issuer server.

5. The system as claimed in claim 1, wherein the issuer server is configured for one or more of:
authenticating the requested payment transaction based on the validation cryptogram received from the kernel server;
implementing the requested payment transaction responsive to successful validation cryptogram based authentication of the requested payment transaction; and
transmitting a transaction confirmation message to the contactless communication enabled device through the kernel server.

6. A method for implementing a contactless payment card based payment transaction, the method comprising implementing at, at least one processor implemented contactless communication enabled device configured for contactless communication and for network communication, the steps of:
establishing a contactless communication protocol based data channel with a contactless payment card through the at least one processor implemented contactless communication enabled device;
receiving payment card information from the contactless payment card over the contactless communication protocol based data channel;
transmitting to a kernel server, a payment transaction request for onward transmission to an issuer server associated with the contactless payment card, the payment transaction request identifying a payment amount, a payee account, and payment account associated with the contactless payment card;
receiving from the kernel server, a validation cryptogram, request wherein the validation cryptogram request has been generated by the issuer server; and
transmitting the validation cryptogram from the contactless payment card to the kernel server, for onward transmission to the issuer server.

7. The method as claimed in claim 6, wherein:
the kernel server is certified for implementing a set of communication protocols that enable implementation of the payment transaction through the issuer server; or
the contactless communication enabled device is uncertified for implementing the set of communication protocols that enable implementation of the payment transaction through the issuer server.

8. The method as claimed in claim 6:
wherein the payment transaction request transmitted to the kernel server:
is transmitted as part of one or more data messages that are in a format that is different from a format necessarily required by one or more of the payment network, acquirer network or issuer network for transaction processing or transaction authentication or transaction validation, or
is transmitted as part of one or more data messages that are in a message format that is non-compliant with or that is different from a predefined Europay-Mastercard-Visa (EMV) message format that is necessarily required by one or more of the payment network, acquirer network or issuer network for transaction processing or transaction authentication or transaction validation, or
is transmitted as part of one or more data messages that is uncertified under one or more certification protocols that are necessarily required by one or more of the payment network, acquirer network or issuer network for transaction processing or transaction authentication or transaction validation, or
is transmitted as part of one or more data messages that are uncertified under one or more EMV certification protocols that are necessarily required by one or more of the payment network, acquirer network or issuer network for transaction processing or transaction authentication or transaction validation;
and wherein the kernel server is configured to transmit the payment transaction request onward to the issuer server, such that said onward transmitted payment transaction request:
is transmitted as part of one or more data messages that are in a format that is compliant with a format necessarily required by one or more of the payment network, acquirer network or issuer network for transaction processing or transaction authentication or transaction validation, or
is transmitted as part of one or more data messages that are in a message format that is compliant with the predefined EMV message format that is necessarily required by one or more of the payment network, acquirer network or issuer network for transaction processing or transaction authentication or transaction validation, or
is transmitted as part of one or more data messages that are certified under one or more certification protocols that are necessarily required by one or more of the payment network, acquirer network or issuer network for transaction processing or transaction authentication or transaction validation, or
is transmitted as part of one or more data messages that are certified under one or more EMV certification protocols that are necessarily required by one or more of the payment network, acquirer network or issuer network for transaction processing or transaction authentication or transaction validation.

9. The method as claimed in claim 6, wherein the kernel server is configured to:
establish at least one additional contactless communication protocol based data channel with at least one additional contactless payment card through an additional processor implemented contactless communication enabled device;
receive payment card information from the additional contactless payment card over the additional contactless communication protocol based data channel;
receive an additional payment transaction request for onward transmission to an additional issuer server associated with the additional contactless payment card, the additional payment transaction request identifying an additional payment amount, an additional payee account, and additional payment account associated with the additional contactless payment card;
receive an additional validation cryptogram request, wherein the additional validation cryptogram request has been generated by the issuer server; and
receive the additional validation cryptogram from the additional contactless payment card, for onward transmission to the issuer server.

10. The method as claimed in claim 6, wherein the issuer server is configured for one or more of:
authenticating the requested payment transaction based on the validation cryptogram received from the kernel server;
implementing the requested payment transaction responsive to successful validation cryptogram based authentication of the requested payment transaction; and
transmitting a transaction confirmation message to the contactless communication enabled device through the kernel server.

11. A computer program product for implementing a contactless payment card based payment transaction, comprising a non-transitory computer usable medium having a computer readable program code embodied therein, the computer readable program code comprising instructions for:
establishing a contactless communication protocol based data channel with a contactless payment card through at least one processor implemented contactless communication enabled device;
receiving payment card information from the contactless payment card over the contactless communication protocol based data channel;
transmitting to a kernel server, a payment transaction request for onward transmission to an issuer server associated with the contactless payment card, the payment transaction request identifying a payment amount, a payee account, and payment account associated with the contactless payment card;
receiving from the kernel server, a validation cryptogram, request wherein the validation cryptogram request has been generated by the issuer server; and
transmitting the validation cryptogram from the contactless payment card to the kernel server, for onward transmission to the issuer server.

12. The computer program product as claimed in claim 11, wherein:
the kernel server is certified for implementing a set of communication protocols that enable implementation of the payment transaction through the issuer server; or
the contactless communication enabled device is uncertified for implementing the set of communication protocols that enable implementation of the payment transaction through the issuer server.

13. The computer program product as claimed in claim 11:
wherein the payment transaction request transmitted to the kernel server:
is transmitted as part of one or more data messages that are in a format that is different from a format necessarily required by one or more of the payment network, acquirer network or issuer network for transaction processing or transaction authentication or transaction validation, or
is transmitted as part of one or more data messages that are in a message format that is non-compliant with or that is different from a predefined Europay-Mastercard-Visa (EMV) message format that is necessarily required by one or more of the payment network, acquirer network or issuer network for transaction processing or transaction authentication or transaction validation, or
is transmitted as part of one or more data messages that is uncertified under one or more certification protocols that are necessarily required by one or more of the payment network, acquirer network or issuer network for transaction processing or transaction authentication or transaction validation, or
is transmitted as part of one or more data messages that are uncertified under one or more EMV certification protocols that are necessarily required by one or more of the payment network, acquirer network or issuer network for transaction processing or transaction authentication or transaction validation;
and wherein the kernel server is configured to transmit the payment transaction request onward to the issuer server, such that said onward transmitted payment transaction request:
is transmitted as part of one or more data messages that are in a format that is compliant with a format necessarily required by one or more of the payment network, acquirer network or issuer network for transaction processing or transaction authentication or transaction validation, or
is transmitted as part of one or more data messages that are in a message format that is compliant with the predefined EMV message format that is necessarily required by one or more of the payment network, acquirer network or issuer network for transaction processing or transaction authentication or transaction validation, or
is transmitted as part of one or more data messages that are certified under one or more certification protocols that are necessarily required by one or more of the payment network, acquirer network or issuer network for transaction processing or transaction authentication or transaction validation, or
is transmitted as part of one or more data messages that are certified under one or more EMV certification protocols that are necessarily required by one or more of the payment network, acquirer network or issuer network for transaction processing or transaction authentication or transaction validation.

14. The computer product as claimed in claim 11, wherein the kernel server is configured to:
establish at least one additional contactless communication protocol based data channel with at least one additional contactless payment card through an additional processor implemented contactless communication enabled device;
receive payment card information from the additional contactless payment card over the additional contactless communication protocol based data channel;
receive an additional payment transaction request for onward transmission to an additional issuer server associated with the additional contactless payment card, the additional payment transaction request identifying an additional payment amount, an additional payee account, and additional payment account associated with the additional contactless payment card;
receive an additional validation cryptogram request, wherein the additional validation cryptogram request has been generated by the issuer server; and
receive the additional validation cryptogram from the additional contactless payment card, for onward transmission to the issuer server.

15. The computer program product as claimed in claim 11, wherein the issuer server is configured for one or more of:
authenticating the requested payment transaction based on the validation cryptogram received from the kernel server;
implementing the requested payment transaction responsive to successful validation cryptogram based authentication of the requested payment transaction; and
transmitting a transaction confirmation message to the contactless communication enabled device through the kernel server.
